(19) United States
(12) Patent Application Publication
(10) Pub. No.: US 2026/0010765 A1
(43) Pub. Date: Jan. 8, 2026

(54) MULTI-SCALE BLOCKS FOR NEURAL NETWORK BASED FILTERS

(71) Applicant: Nokia Technologies Oy, Espoo (FI)

(72) Inventors: Francesco CRICRÌ, Tampere (FI); Maria Claudia SANTAMARIA GOMEZ, Tampere (FI); Ruiying YANG, Tampere (FI)

(21) Appl. No.: 19/259,204

(22) Filed: Jul. 3, 2025

Related U.S. Application Data
(60) Provisional application No. 63/667,845, filed on Jul. 5, 2024.

(51) Int. Cl. G06N 3/0455; G06N 3/084

(52) U.S. Cl. CPC G06N 3/0455; G06N 3/084

(57) ABSTRACT

An example apparatus includes: at least one processor; and at least one memory storing instructions that, when executed by the at least one processor, cause the apparatus at least to: receive at least one input tensor; and process the at least one input tensor using a group of layers of at least one neural network to obtain a processed tensor.

### TECHNICAL FIELD

The examples and non-limiting embodiments relate generally to multi-scale blocks for neural network based filters.

### BACKGROUND

It is known to perform data compression and data decompression in a multimedia system.

### BRIEF DESCRIPTION OF THE DRAWINGS

The foregoing embodiments and other features are explained in the following description, taken in connection with the accompanying drawings, wherein:

FIG. 1 an example of a video coding pipeline with neural network components.

FIG. 2 shows an example of an end-to-end learned codec.

FIG. 3 shows a system pipeline for video coding for machines (VCM).

FIG. 4 shows an example of encoder-side operations.

FIG. 5 shows an example of decoder or receiver side operations.

FIG. 6 shows an example where a group of layers of a neural network are used as part of a data encoder and/or data decoder.

FIG. 7 shows an example where an output of a neural network group of layers, and the outputs of two upsample operations are combined using a combination operation.

FIG. 8 shows an example where the outputs of different neural network subgroups of layers that use different dilation rates are combined.

FIG. 9 shows an example architecture of a neural network filter.

FIG. 10 shows an example of a modified backbone block for the example neural network filter architecture shown in FIG. 9.

FIG. 11 shows an encoder according to an embodiment.

FIG. 12 shows a decoder according to an embodiment.

FIG. 13 is a block diagram illustrating a system in accordance with an example.

FIG. 14 is an example apparatus configured to implement the examples described herein.

FIG. 15 shows a representation of an example of non-volatile memory media used to store instructions that implement the examples described herein.

FIG. 16 is an example method, based on the examples described herein.

FIG. 17 is an example method, based on the examples described herein.

FIG. 18 is an example method, based on the examples described herein.

### DETAILED DESCRIPTION OF EXAMPLE EMBODIMENTS

### Fundamentals of Neural Networks

A neural network (NN) may be described as a computation graph consisting of several layers of computation. Each layer may consist of one or more units, where each unit performs an elementary computation. A unit is connected to one or more other units, and the connection may be associated with a weight. The weight may be used for scaling the signal passing through the associated connection. Weights are learnable parameters, i.e., values which can be learned from training data. There may be other learnable parameters, such as those of batch-normalization layers.

In some neural networks, such as convolutional neural networks for image classification, initial layers (those close to the input data) extract semantically low-level features such as edges and textures in images, whereas intermediate layers extract more high-level features. After the feature extraction layers there may be one or more layers performing a certain task, such as classification, semantic segmentation, object detection, denoising, style transfer, super-resolution, etc.

Neural networks are being utilized in an ever-increasing number of applications for many different types of devices, such as mobile phones. Examples include image and video analysis and processing, social media data analysis, device usage data analysis, etc.

One property of neural nets (and other machine learning tools) is that they are able to learn properties from input data, e.g., in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss or loss function. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss, by means of gradient descent technique. In one example, at each training iteration, gradients of the loss function with respect to one or more weights or parameters of the NN are computed, for example by backpropagation technique; the computed gradients are then used by an optimization routine, such as Adam or Stochastic Gradient Descent (SGD) to obtain an update to the one or more weights or parameters.

The terms “model”, “neural network”, “neural net” and “network” are used interchangeably herein, and also the weights of neural networks are sometimes referred to as learnable parameters or simply as parameters.

Training a neural network is an optimization process, but the final goal may be different from the typical goal of optimization. In optimization, the only goal is to minimize a function. In machine learning, the goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data is usually split into at least two sets, the training set and the validation set. The training set is used for training the network, i.e., to modify its learnable parameters in order to minimize the loss. The validation set is used for checking the performance of the network on data which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model may be in the regime of overfitting. This means that the model has just memorized the training set's properties and performs well only on that set, but performs poorly on a set not used for tuning its parameters.

### Fundamentals of Video/Image Coding

Video codec consists of an encoder that transforms the input video into a compressed representation suited for storage/transmission and a decoder that can decompress the compressed video representation back into a viewable form. Typically encoder discards some information in the original video sequence in order to represent the video in a more compact form (that is, at lower bitrate).

Typical hybrid video codecs, for example ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, the encoder can control the balance between the accuracy of the pixel representation (picture quality) and size of the resulting coded video representation (file size or transmission bitrate).

Inter prediction, which may also be referred to as temporal prediction, motion compensation, or motion-compensated prediction, exploits temporal redundancy. In inter prediction the sources of prediction are previously decoded pictures (also known as reference pictures).

In temporal inter prediction, the sources of prediction are previously decoded pictures in the same scalable layer. In intra block copy (IBC; also known as intra-block-copy prediction), prediction may be applied similarly to temporal inter prediction but the reference picture is the current picture and only previously decoded samples can be referred in the prediction process. Inter-layer or inter-view prediction may be applied similarly to temporal inter prediction, but the reference picture is a decoded picture from another scalable layer or from another view, respectively. In some cases, inter prediction may refer to temporal inter prediction only, while in other cases inter prediction may refer collectively to temporal inter prediction and any of intra block copy, inter-layer prediction, and inter-view prediction provided that they are performed with the same or similar process than temporal prediction. Inter prediction, temporal inter prediction, or temporal prediction may sometimes be referred to as motion compensation or motion-compensated prediction.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In typical video codecs the motion information is indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signaled among a list of motion field candidate list filled with motion field information of available adjacent/co-located blocks.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R \qquad ( Equation 1 )$$

In the above equation, C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding specifications may enable the use of supplemental enhancement information (SEI) messages or alike. Some video coding specifications include SEI NAL units, and some video coding specifications contain both prefix SEI NAL units and suffix SEI NAL units, where the former type can start a picture unit or alike and the latter type can end a picture unit or alike. An SEI NAL unit contains one or more SEI messages, which are not required for the decoding of output pictures but may assist in related processes, such as picture output timing, post-processing of decoded pictures, rendering, error detection, error concealment, and resource reservation. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

### Information on Neural Network Based Image/Video Coding

Recently, neural networks (NNs) have been used in the context of image and video compression, by following mainly two approaches.

In a first approach, NNs are used to replace one or more of the components of a non-learned codec such as a VVC/H.266-compliant codec. Here, “non-learned” means those codecs whose components and their parameters are typically not learned from data by means of machine learning techniques. Examples of components that may be implemented as neural networks are: An in-loop filter, for example a NN that works as an additional in-loop filter with respect to the non-learned loop filters, or a NN that works as the only additional in-loop filter, thus replacing any other in-loop filter; Intra-frame prediction; Inter-frame prediction; Transform and/or inverse transform; Probability model for lossless coding; Etc.

In a second approach, commonly referred to as “end-to-end learned compression” (or end-to-end learned codec), NNs are used as the main components of the image/video codecs. However, the codec may still comprise components which are not based on machine learning techniques. In this second approach, two design options are as follows:

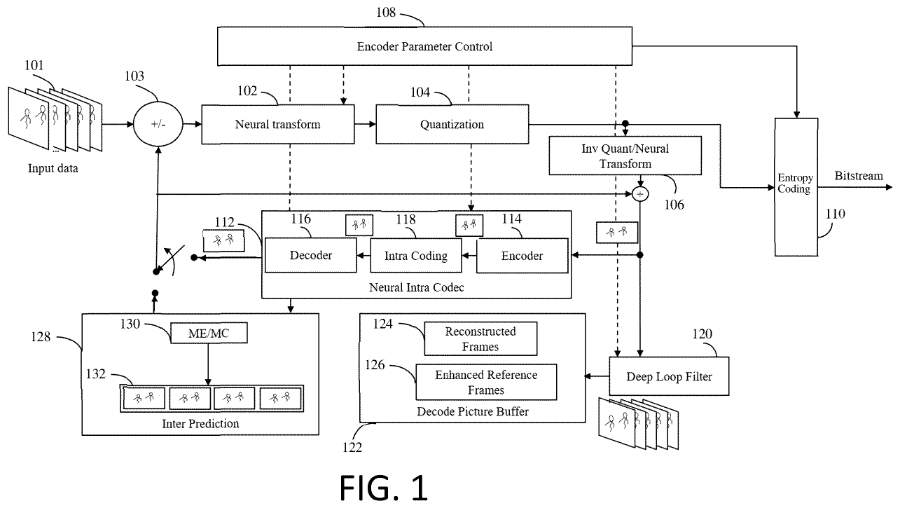

Option 1: re-use the non-learned video coding pipeline, but replace most or all the components with NNs, as shown in FIG. 1.

Referring to FIG. 1, it illustrates an example of modified video coding pipeline based on neural networks. An example of neural network may include, but is not limited, a compressed representation of a neural network. FIG. 1 is shown to include following components:
A neural transform block or circuit 102: this block or circuit transforms the output of a summation/subtraction operation 103 to a new representation of that data, which may have lower entropy and thus be more compressible.
A quantization block or circuit 104: this block or circuit quantizes an input data 101 to a smaller set of possible values.
An inverse transform and inverse quantization blocks or circuits 106. These blocks or circuits perform the inverse or approximately inverse operation of the transform and the quantization, respectively.
An encoder parameter control block or circuit 108. This block or circuit may control and optimize some or all the parameters of the encoding process, such as parameters of one or more of the encoding blocks or circuits.
An entropy coding block or circuit 110. This block or circuit may perform lossless coding, for example, based on entropy. One popular entropy coding technique is arithmetic coding.
A neural intra-codec block or circuit 112. This block or circuit may be an image compression and decompression block or circuit, which may be used to encode and decode an intra frame. An encoder 114 may be an encoder block or circuit, such as the neural encoder part of an auto-encoder neural network. A decoder 116 may be a decoder block or circuit, such as the neural decoder part of an auto-encoder neural network. An intra-coding block or circuit 118 may be a block or circuit performing some intermediate steps between encoder and decoder, such as quantization, entropy encoding, entropy decoding, and/or inverse quantization.
A deep loop filter block or circuit 120. This block or circuit performs filtering of reconstructed data, in order to enhance it.
A decode picture buffer block or circuit 122. This block or circuit is a memory buffer, keeping the decoded frame, for example, reconstructed frames 124 and enhanced reference frames 126 to be used for inter prediction.
An inter-prediction block or circuit 128. This block or circuit performs inter-frame prediction, for example, predicts from frames, for example, frames 132, which are temporally nearby. An ME/MC 130 performs motion estimation and/or motion compensation, which are two key operations to be performed when performing inter-frame prediction. ME/MC stands for motion estimation/motion compensation.

In this example (Option 1), the forward and inverse transforms were replaced with two neural networks. Also, the loop filter is a neural network.

Option 2 (also referred to as end-to-end learned coding): re-design the whole pipeline as a neural network auto-encoder with a quantization and lossless coding in the middle part, as follows:
Encoder NN (also referred to as neural network based encoder, or NN encoder): may perform a non-linear transformation of the input. The output is typically referred to as latent tensor.
Quantization and lossless encoding of the encoder NN's output.
Lossless decoding and dequantization.
Decoder NN (also referred to as neural network based decoder, or NN decoder): may perform a non-linear inverse transformation from dequantized latent tensor to a reconstructed input.

It is to be understood that even in end-to-end learned approaches, there may be components which are not learned from data, such as the arithmetic codec.

More information on option 2 is provided in the following description.

### Further Information on Neural Network-Based End-to-End Learned Coding

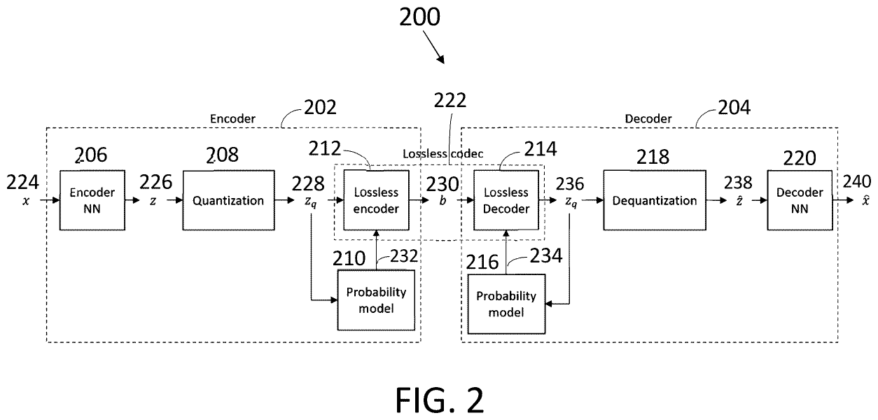

FIG. 2 illustrates an example neural network-based end-to-end learned coding, such as an end-to-end learned video coding system 200 or an end-to-end learned image coding system 200. Even though some examples are provided with respect to coding images or videos, it is to be understood that other types of data may be coded in a similar way, such as audio, speech, text, features, etc. As shown in FIG. 2, a typical neural network-based end-to-end learned coding system contains an encoder 202 and a decoder 204.

The encoder 202 comprises an encoder NN 206, a quantizer or quantization 208, a probability model 210, a lossless encoder 212 (for example arithmetic encoder). The decoder 204 comprises a lossless decoder 214 (for example, an arithmetic decoder), a probability model 216, a dequantizer or dequantization 218, and a decoder NN 220.

It is to be noted that the probability model 210 present at encoder side and the probability model 216 present at decoder side may be same or substantially the same. For example, they may be two copies of the same probability model.

The lossless encoder 212 and the lossless decoder 214 form a lossless codec 222. A lossless codec such as lossless codec 222 may be an entropy-based lossless codec. An example of lossless codec is an arithmetic codec, such as a context-adaptive binary arithmetic coding CABAC.

The encoder NN 206 and decoder NN 220 are typically two neural networks, or mainly comprise neural network components.

The probability model (210, 216) may also be a neural network and/or comprise mainly neural network components, and may be referred to as neural network based probability model or learned probability model.

Sometimes, the term lossless codec may refer to a system that comprise also the probability model, in addition to, for example, an arithmetic encoder and an arithmetic decoder.

The quantizer 208, dequantizer 218 and lossless codec 222 are typically not based on neural network components, but they may also comprise neural network components, potentially.

The encoder NN 206 takes an input x 224, which may comprise, for example, an image to be compressed. The encoder NN 206 outputs a latent tensor z 226. In one example, the latent tensor 226 may be a 3D tensor, where the three dimensions of the latent tensor 226 represent a channel dimension, a vertical dimension (also sometimes referred to as height dimension) and a horizontal dimension (also sometimes referred to as width dimension). In another example, the latent tensor 226 may be a 4D tensor, where the four dimensions of the latent tensor 226 represent sample dimension (also sometimes referred to as batch dimension, which is the dimension along which different samples of data can be placed), a channel dimension, a vertical dimension (also sometimes referred to as height dimension) and a horizontal dimension (also sometimes referred to as width dimension). The latent tensor 226 is input to a quantization operation 208, obtaining a quantized latent tensor z_{q} 228. The quantized latent tensor 228 is lossless-encoded into a bitstream b 230 by the lossless encoder 212, based also on the output 232 of the probability model 210. In particular, the probability model takes as input at least part of the quantized latent tensor 228 and outputs 232 an estimate of a probability or an estimate of a probability distribution or an estimate of one or more parameters of a probability distribution for one or more elements of the quantized latent tensor. The bitstream 230 represents an encoded or compressed version of the input x 224.

The bitstream 230 is lossless-decoded by the lossless decoder 214 also based on the output 234 of the probability model 216 present at decoder side, obtaining a quantized latent tensor z_{q} 236. The quantized latent tensor 236 is dequantized 218, obtaining a reconstructed latent tensor \hat{z} 238. The reconstructed latent tensor 238 is input to a decoder NN 220, obtaining a reconstructed input \hat{x} 240, i.e., a reconstructed version of the input x 224. The reconstructed input 240 may also be referred to as reconstructed data, or reconstruction, or decoded data, or decoded input, or decoded output, or decoded image, or decoded video, and the like.

This is a simplified description of an end-to-end learned codec 200, and it is to be understood that more sophisticated designs or variations of this design are possible.

It is to be understood that, in some implementations or in some embodiments described herein, the encoder 202 may comprise some or all of the components of the decoder 204, even if the some or all of the components of the decoder 204 are not shown as being part of the encoder 202 in FIG. 2.

The neural network components, or a subset of the neural network components, of an end-to-end learned codec (such as end-to-end learned codec 200) may be trained by minimizing a rate-distortion loss function:

$$L = D + λ R \qquad ( Equation 2 )$$

In Equation 2, D is a distortion loss term, R is a rate loss term, and λ is a weight that controls the balance between the two losses. The distortion loss term may be referred to also as reconstruction loss term, or simply reconstruction loss. The rate loss term may be referred to simply as rate loss.

The distortion loss term measures the quality of the reconstructed or decoded output, and may comprise (but may not be limited to) one or more of the following: Mean square error (MSE); Structure similarity (SSIM); MS-SSIM; Losses derived from the use of a pretrained neural network. For example, error(f1, f2), where f1 and f2 are the features extracted by a pretrained neural network for the input data and the decoded data, respectively, and error( ) is an error or distance function, such as L1 norm or L2 norm; Losses derived from the use of a neural network that is trained simultaneously with the end-to-end learned codec. For example, adversarial loss can be used, which is the loss provided by a discriminator neural network that is trained adversarially with respect to the codec, following the settings in the context of Generative Adversarial Networks (GANs) and their variants; Loss that is related to a performance of one or more machine analysis tasks or to an estimated performance of one or more machine analysis tasks, where the one or more machine analysis tasks may comprise classification, object detection, image segmentation, instance segmentation, etc. In one example, the estimated performance of one or more machine analysis tasks may comprise a distortion computed based at least on a first set of features extracted from an output of the decoder and a second set of features extracted from a respective ground truth data, where the first set of features and the second set of features are output by one or more layers of a pretrained feature-extraction neural network.

Multiple distortion losses may be used and integrated into D, such as a weighted sum of MSE and SSIM.

The rate loss term may be used to train the encoder NN to output a low-entropy latent tensor, or a latent tensor such that the quantized latent tensor has low entropy, or a latent tensor such that the probability distribution of the quantized latent tensor can be better estimated or predicted by the probability model.

The rate loss term may be used to train the probability model to better estimate or predict the probability distribution of the quantized latent tensor.

Examples of the rate loss terms are the following:
In one example, the rate loss term is derived from the output of the probability model, and it represents the estimated entropy of the quantized latent representation, which indicates the number of bits necessary to represent the quantized latent tensor.
   A sparsification loss, i.e., a loss that encourages the quantized latent tensor to comprise many zeros. Examples are L0 norm, L1 norm, L1 norm divided by L2 norm.

In order to train the neural network components, or a subset of the neural network components, of an end-to-end learned codec, one or more reconstruction losses may be used, and one or more rate losses may be used. In one example the one or more reconstruction losses and/or one or more rate losses are combined by means of a weighted sum. Typically, the different loss terms are weighted using different weights, and these weights determine how the final system performs in terms of rate-distortion performance. For example, if more weight is given to the reconstruction losses with respect to the rate losses, the system may learn to compress less but to reconstruct with higher accuracy (as measured by a metric that correlates with the reconstruction losses). These weights are usually considered to be hyper-parameters of the training process, and may be set manually by the person designing the training process, or automatically for example by grid search or by using additional neural networks.

In one case, the training process may be performed jointly with respect to the distortion loss D and the rate loss R. In another case, the training process may be performed in two alternating phases, where in a first phase only the distortion loss D may be used, and in a second phase only the rate loss R may be used.

For lossless video/image compression, the system would comprise only the probability model and lossless encoder and lossless decoder. The loss function would comprise only the rate loss, since the distortion loss is always zero (i.e., no loss of information).

As used herein, the inference phase, or inference stage, or inference time, or test time, are referred to as the phase when a neural network or a codec is used for its purpose, such as encoding and decoding an input image.

### Information on Video Coding for Machines (VCM)

Reducing the distortion in image and video compression is often intended to increase human perceptual quality, as humans are considered to be the end users, i.e. consuming/watching the decoded images or videos. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. For example, such analysis tasks may be performed by neural networks.

It is likely that the device where the analysis takes place has multiple “machines” or neural networks (NNs). These multiple machines may be used in a certain combination which is for example determined by an orchestrator sub-system. The multiple machines may be used for example in succession, based on the output of the previously used machine, and/or in parallel. For example, a video may be analyzed by one machine (NN) for detecting pedestrians, by another machine (another NN) for detecting cars, and by another machine (another NN) for estimating the depth of all the pixels in the frames.

Example use cases and applications are self-driving cars, video surveillance cameras and public safety, smart sensor networks, smart TV and smart advertisement, person re-identification, smart traffic monitoring, drones, etc. In addition to image and video data, automatic analysis and processing is increasingly being performed for other types of data, such as audio, speech, text.

Compressing (and decompressing) data where the end user comprises machines (e.g., neural networks) is commonly referred to as compression or coding for machines. In the case of video data, it is referred to as video compression or coding for machines (VCM).

Compressing for machines may differ from compressing for humans for example with respect to the algorithms and technology used in the codec, or the training losses used to train any neural network components of the codec, or the evaluation methodology of codecs.

It is to be understood that, when considering the case of coding for machines, the terms “receiver-side” or “decoder-side” are used to refer to the physical or entity or device which contains one or more machines, and runs these one or more machines on some encoded and eventually decoded video representation which is encoded by another physical or entity or device, the “encoder-side device”.

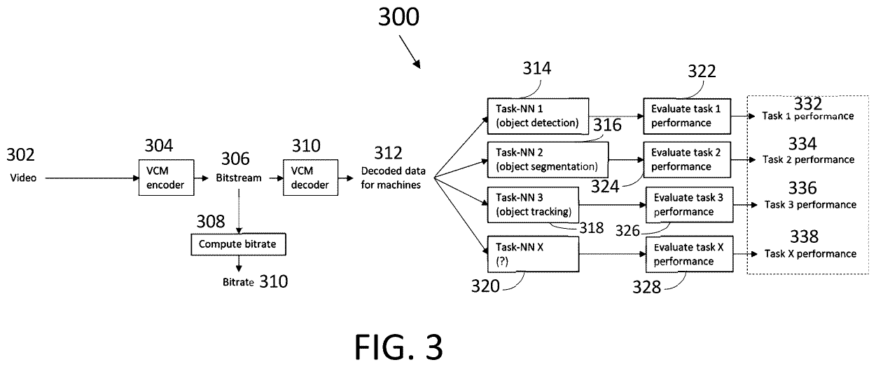

FIG. 3 is a general illustration of a pipeline 300 of Video Coding for Machines. A VCM encoder 304 encodes the input video 302 into a bitstream 306. A bitrate 310 may be computed 308 from the bitstream 306, as a measure of the size of the bitstream. A VCM decoder 310 decodes the bitstream 306 that was produced by the VCM encoder 304. The output of the VCM decoder 310 is referred in the figure as “Decoded data for machines” 312. This data 312 may be considered as the decoded or reconstructed video. However, in some implementations of this pipeline 300, this data 312 may not have same or similar characteristics as the original video 302 which was input to the VCM encoder 304. For example, this data 312 may not be easily understandable by a human by simply rendering the data onto a screen. The output 312 of VCM decoder 310 is then input to one or more task neural networks. In the figure, for the sake of illustrating that there may be any number of task-NNs, there are three example task-NNs (object detection task NN 314, object segmentation task NN 316, object tracking task NN 318), and a non-specified one (Task-NN X 320). One goal of VCM may be to obtain a low bitrate while guaranteeing that the task-NNs (314, 316, 318, 320) still perform well in terms of the evaluation metric associated to each task.

It is to be understood that, in some cases, the VCM decoder 310 may not be present. In one example, the machines (314, 316, 318, 320) are run directly on the bitstream 306. In some other cases, the VCM decoder 310 may comprise only a lossless decoding stage, and the lossless decoded data is provided as input to the machines (314, 316, 318, 320). In yet some other cases, the VCM decoder 310 may comprise a lossless decoding stage following by a dequantization operation, and the loss-decoded and dequantized data is provided as input to the machines.

As shown in FIG. 3, the performance of task NN 314 is evaluated 322 to generate task performance 332, the performance of task NN 316 is evaluated 324 to generate task performance 334, the performance of task NN 318 is evaluated 326 to generate task performance 336, and the performance of task NN 320 is evaluated 328 to generate task performance 338.

When a video encoder, such as a H.266/VVC encoder, is used as a VCM encoder, one or more of the following approaches may be used to adapt the encoding to be suitable to machine analysis tasks:
One or more regions of interest (ROIs) may be detected. An ROI detection method may be used. For example, ROI detection may be performed using a task NN, such as an object detection NN. In some cases, ROI boundaries of a group of pictures or an intra period may be spatially overlaid and rectangular areas may be formed to cover the ROI boundaries. The detected ROIs (or rectangular areas, likewise) may be used in one or more of the following ways:
The quantization parameter (QP) may be adjusted spatially in a manner that ROIs are encoded using finer quantization step size(s) than other regions. For example, QP may be adjusted CTU-wise.
   The video is preprocessed to contain only the ROIs, while the other areas are replaced by one or more constant values or removed.
The video is preprocessed so that the areas outside the ROIs are blurred or filtered.
   A grid is formed in a manner that a single grid cell covers a ROI. Grid rows or grid columns that contain no ROIs are downsampled as preprocessing to encoding.
   Quantization parameter of the highest temporal sublayer(s) is increased (i.e. coarser quantization is used) when compared to practices for human watchable video.
   The original video is temporally downsampled as preprocessing prior to encoding. A frame rate upsampling method may be used as postprocessing subsequent to decoding, if machine analysis at the original frame rate is desired.
A filter is used to preprocess the input to the encoder. The filter may be a machine learning based filter, such as a convolutional neural network.

It is to be understood that, in the context of video coding for machines, the terms “machine vision”, “machine vision task”, “machine task”, “machine analysis”, “machine analysis task”, “computer vision”, “computer vision task”, “task network” and “task” may be used interchangeably.

Also, it is to be understood that, in the context of video coding for machines, the terms “machine consumption” and “machine analysis” may be used interchangeably.

### Neural Network Based Filtering

A neural network may be used for filtering or processing input data. Such a neural network may be referred to as a neural network based filter, or simply NN filter or just filter. A NN filter may comprise one or more neural networks, and/or one or more components that may not be categorized as neural networks.

The purpose of a NN filter may comprise (but may not be limited to) visual enhancement, colorization, upsampling, super-resolution, inpainting, temporal extrapolation, generating content, and the like.

In some video codecs, a neural network may be used as filter in the encoding and decoding loop (also referred to simply as coding loop), and it may be referred to as neural network loop filter, or neural network in-loop filter. The NN loop filter may replace all other loop filters of an existing video codec, or may represent an additional loop filter with respect to the already present loop filters in an existing video codec.

In one example, a codec is a modified VVC/H.266 compliant codec (e.g., a VVC/H.266 compliant codec that has been modified and thus it may not be compliant to the VVC/H.266) that comprises one or more NN loop filters. An input to the one or more NN loop filters may comprise at least a reconstructed block or frames (simply referred to as reconstruction) or data derived from a reconstructed block or frame (e.g., the output of a loop filter). The reconstruction may be obtained based on predicting a block or frame (e.g., by means of intra-frame prediction or inter-frame prediction) and performing residual compensation. The one or more NN loop filters may enhance the quality of at least one of their input, so that a rate-distortion loss is decreased. The rate may indicate a bitrate (estimate or real) of the encoded video. The distortion may indicate a pixel fidelity distortion such as the following:
Mean-squared error (MSE)
Mean absolute error (MAE)
Mean Average Precision (mAP) computed based on the output of a task NN (such as an object detection NN) when the input is the output of the post-processing NN;

Other machine task-related metric, for tasks such as object tracking, video activity classification, video anomaly detection, etc.

The enhancement may result into a coding gain, which can be expressed for example in terms of BD-rate or BD-PSNR.

A neural network filter may be used as post-processing filter for a codec, e.g., may be applied to an output of an image or video decoder in order to remove or reduce coding artifacts. In one example, the NN filter is used as a post-processing filter where the input comprises data that is output by or is derived from an output of a decoder (e.g. a non-learned decoder), such as a decoder that is compliant with the VVC/H.266 standard. In another example, the NN filter is used as a post-processing filter where the input comprises data that is output by or is derived from an output of a decoder of an end-to-end learned decoder.

### Input to a NN Filter

In the case of filtering images, a filter may take as input at least one or more first images to be filtered and may output at least one or more second images, where the one or more second images are the filtered version of the one or more first images. In one example, the filter takes as input one image and outputs one image. In another example, the filter takes as input more than one image and outputs one image. In another example, the filter takes as input more than one image and outputs more than one image.

It is to be understood that a filter may take as input also other data (also referred to as auxiliary data, or extra data) than the data that is to be filtered, such as data that can aid the filter to perform a better filtering than if no auxiliary data was provided as input. In one example, the auxiliary data comprises information about prediction data, and/or information about the picture type, and/or information about the slice type, and/or information about a Quantization Parameter (QP) used for encoding, and/or information about boundary strength, etc. In one example, the filter takes as input one image and other data associated to that image, such as information about the quantization parameter (QP) used for quantizing and/or dequantizing that image, and outputs one image.

### Information on Overfitting a Neural Network Filter

A NN filter can be adapted at test time based at least on part of the data to be encoded and/or decoded and/or post-processed.

Although, for simplicity, the case of a NN filter is being considered herein, similar adaptation may be performed for other coding tools and/or post-processing tools that are based on neural network technology. For example, a neural network based intra-frame prediction, or a neural network based inter-frame prediction, etc.

Such operation may be referred to, for example, with one of the following terms, when their meaning is clear from the context: adaptation, content adaptation, overfitting, finetuning, optimization, specialization, and the like.

The NN filter that results from the adaptation process may be referred to, for example, with one of the following terms: adapted filter, content-adapted filter, overfitted filter, finetuned filter, optimized filter, specialized filter, and the like.

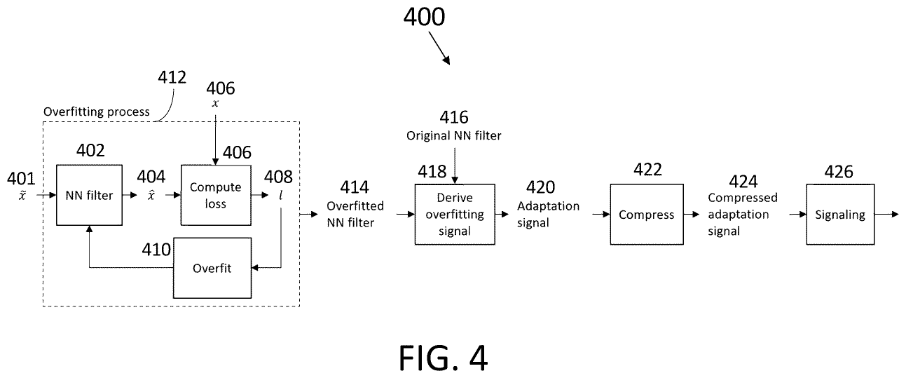

The overfitting process may be performed at encoder side based on a training process. The resulting overfitted filter is then used to derive an overfitting signal, or adaptation signal. The adaptation signal may be compressed and then signaled from the encoder to the decoder, in or along a bitstream that represents encoded data, such as an encoded image or video. FIG. 4 illustrates an example of such encoder-side operations of encoder 400.

In this figure, \tilde{x} 401 represents an input to the NN filter 402, \hat{x} 404 represents an output of the NN filter 402, x 406 represents a ground-truth data associated with \tilde{x} 401, “Compute loss” 406 computes a training loss l 408 in order to overfit the NN filter 402, “Overfit” 410 uses l 408 to overfit the NN filter 402. As a result of the overfitting process 412, an overfitted NN filter 414 is obtained, which is used, together with the original NN filter 416, to derive 418 an adaptation signal 420. The adaptation signal 420 is compressed 422, and the compressed adaptation signal 424 is signaled 426 to a decoder or receiver.

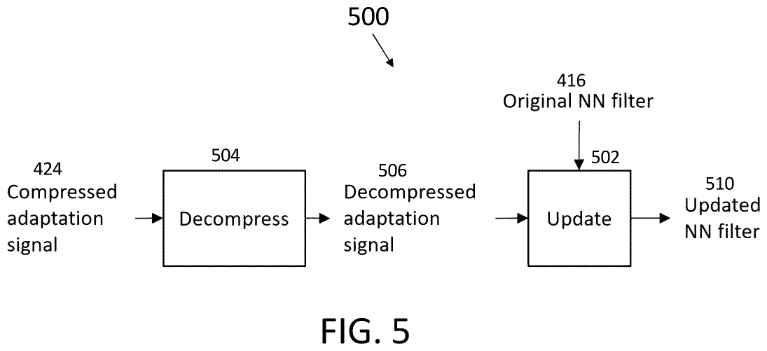

Referring to FIG. 5, at the decoder side including at decoder 500, the overfitting signal, or a signal derived from the overfitting signal 424 such as decompressed adaptation signal 506 resulting from decompression 504 of the compressed adaptation signal 424, is used to update 502 the NN filter 416. The updated NN filter 510 is then used to filter one or more pictures, or one or more blocks. FIG. 5 thus illustrates an example of such decoder or receiver side operations (500).

The NN filter (414) that is obtained from the overfitting process at encoder side 400 may be different from the NN filter 510 that is obtained from the updating process 502 at decoder side 500. For example, one reason may be that the adaptation signal 420 may be compressed 422 in a lossy way. Thus, the former NN filter (414) may be referred to as overfitted filter or adapted filter (or other similar terms, see above), and the latter NN filter may be referred to as updated filter 510.

### Overfitting Process Performed at Encoder Side

The adaptation process starts with an initial NN filter (416, 402). It is to be noted that, before the adaptation or overfitting process has started, the NN filter 416 and the NN filter 402 may be same or substantially same. During the adaptation or overfitting process, the NN filter 402 may be modified, thus may become different from the NN filter 416. In one example, the initial NN filter (416, 402) is a pretrained NN filter, which was pretrained during an offline stage on a sufficiently large dataset. In another example, the initial NN filter (416, 402) is a randomly initialized NN filter.

In the adaptation, one or more parameters of the NN filter 402 may be adapted. Examples of such parameters may include (but may not be limited to) the following: The bias terms of a convolutional neural network; Multiplier parameters, that multiply one or more tensors produced by the NN filter 402, such as one or more feature tensors that are output by respective one or more layers of the NN filter 402; Parameters of the kernels of a convolutional neural network; Parameters of an adapter layer; One or more arrays or tensors that are used as input to respective one or more layers of the NN filter 402.

The adaptation may be performed by means of a training process, e.g., by minimizing a loss function (406) until a stopping criterion is met. The data used for this training process may comprise one or more pictures or blocks of input 401 to the NN filter 402 and associated respective one or more pictures or blocks of ground-truth data 406. In one example where the filter is an in-loop filter, the input to the NN filter 402 is reconstruction data, after prediction and residual compensation (e.g., after a decoded residual has been added to or combined with a predicted picture or block); the ground-truth data is the uncompressed data that is given as input to the encoder. In one example where the filter is a post-processing filter, the input to the NN filter 402 is decoded data (e.g., the output of a video decoder); the ground-truth data 406 is the uncompressed data that is given as input to the encoder.

Thus, the “overfitting process” is an iterative process where, at each iteration, the NN filter 402 may change; so, at the beginning, NN filter 402 and original NN filter 416 are the same initial filter; then, with each overfitting iteration, NN filter 402 may change, eventually becoming the overfitted NN filter 414.

The loss function (used with compute loss 406) used during the training process may comprise one or more distortion loss functions (also referred to as reconstruction loss functions) and zero or more rate loss functions. A rate loss function may measure, for example, the cost in terms of bitrate of signaling any adaptation signal, such as updates to the parameters of the NN filter. A distortion loss function may comprise one of MSE, MS-SSIM, VMAF, etc.

### Deriving the Adaptation Signal

The adaptation signal 420 may be derived based on the adapted NN filter 414 and on the original NN filter 416 (e.g., the NN filter 402 before the overfitting process).

In one example, the adaptation signal 420 comprises an update to one or more parameters of the NN filter (414, 416), e.g., a difference between the values of one or more parameters of the NN filter 414 and the values of respective one or more parameters of the NN filter 416. Such update may also be referred to as a weight update, or parameter update. Such update may be computed, for example, by subtracting the values of the adapted parameters (i.e., the parameters of the adapted NN filter 414) from the corresponding values of the original parameters (i.e., the parameters of the original NN filter 416).

In another example, the adaptation signal 420 comprises the parameters (of the NN filter 414) that were adapted, also referred to as updated parameters, or adapted parameters, or adapted weights, or overfitted parameters, and the like.

### Compression of Adaptation Signal

In order to keep the size of the adaptation signal low, the adaptation signal 420 may go through one or more compression steps 422, such as sparsification, quantization and lossless coding.

In one example, an encoder that compresses the adaptation signal into a bitstream that is compliant with a neural network compression standard, such as MPEG NNC (ISO/IEC 15938-17), may be used.

### Signaling

The compressed adaptation signal 424 may be signaled 426 from encoder to decoder in or along a bitstream that represents encoded image or video data. In one example, the compressed adaptation signal 424 is signaled 426 in an Adaptation Parameter Set (APS) syntax structure of a video coding bitstream. In another example, the compressed adaptation signal 424 is signaled 426 in a Supplemental Enhancement Information (SEI) message of a video coding bitstream. Signaling 426 may comprise also other information which is associated with the adaptation signal 424 and that may be required for correctly parsing and/or decompressing and/or using the adaptation signal 424, such as any quantization parameters. It is to be understood that, in some embodiments or use cases, the compressed adaptation signal 424 may be the only signal or bitstream that is sent from an encoder to a decoder and may represent an encoded image or video.

### Decoder or Receiver Side Operations

At decoder side 500, the signaled compressed adaptation signal 424 is received and decompressed 504. The decompressed adaptation signal 506 may then be used to update 502 the NN filter 416, resulting in updated NN filter 510. In one example, where the adaptation signal (424, 506) comprises a weight update, where the weight update comprises one or more updates to respective one or more parameters of the NN filter 416, the update operation 502 adds the one or more updates to the one or more parameters. In another example, where the adaptation signal (424, 506) comprises one or more updated or adapted parameters, the update operation 502 replaces respective one or more parameters of the NN filter 416 with the one or more updated or adapted parameters. Once the NN filter 416 has been updated 502 based on the adaptation signal (424, 506), the updated NN filter 510 may be used for its purpose. For example, for filtering an input picture or an input block, or for decoding an image.

### Terminology

The terms frame, picture and image may be used interchangeably. For example, the input and output to an end-to-end learned codec may be pictures. The input and output of a NN filter may be pictures. It is to be understood that also the term block, when it refers to a portion of a picture, may be simply referred to as frame or picture or image. In other words, at least some of the embodiments herein, even when described as applied to a picture, may be applicable also to a block, e.g., to a portion of a picture.

Neural networks are being increasingly used as part of encoding and/or decoding pipelines, such as in image or video codecs. One example is a neural network based in-loop filter.

Improving the performance of such neural networks, in terms of one or more performance metrics, is beneficial for improving the overall performance of the encoder and/or decoder that comprises the neural network.

Described herein are embodiments targeting the improvement of the performance of such neural networks.

### General Info

Considered by the examples described herein is a neural network that is present in an encoder and/or in a decoder, such as in a video encoder and/or a video decoder. In one example, the neural network (NN) may be a NN in-loop filter. In another example, the NN may be a NN post-processing filter. In yet another example, the NN may be used as part of an intra-frame prediction process. In yet another example, the NN may be used as part of an inter-frame prediction process. In yet another example, the NN may be used as part of a transformation process, such as a transform of a prediction residual signal. In yet another example, the NN may be used as part of an end-to-end learned codec, such as a NN that takes a lossless-decoded latent tensor and outputs reconstructed or decoded data. In yet another example, the NN may perform spatial upsampling. In yet another example, the NN may perform super-resolution.

For the sake of simplicity, at least some embodiments or examples are described as applied to a NN filter that enhances or improves the quality of one of its inputs, such as a NN-based in-loop filter. However, it is to be understood that the at least some embodiments or examples may be valid or applicable to other NNs than a NN filter.

Also, for the sake of simplicity, at least some embodiments or examples are described as applied to a NN that is used for decoding a data item. However, it is to be understood that the at least some embodiments or examples may be valid or applicable to a NN that is used for post-processing a decoded data item or data derived from a decoded data item.

While at least some embodiments are described such that the input and output data are in the form of images or (video) frames or pictures, those embodiments may be applicable also to other types of data, such as audio frames. Furthermore, while at least some embodiments are described by considering a full image, those embodiments may be applicable also to one or more blocks or portions of an image.

It is to be noted that in some cases an encoder comprises a decoder or a subset of components of a decoder.

It is to be noted that in some cases an encoder comprises or has access to a post-processing operation, such as a neural network based post-processing filter.

### Main Embodiment

In one embodiment, at least one first group of layers of a neural network used as part of a data encoder and/or data decoder, such as an in-loop filter in a video encoder and/or video decoder, takes as input a first input tensor comprising a first spatial resolution and may comprise two or more second groups of layers that process respective two or more second input tensors, obtaining respective two or more processed tensors. The two or more processed tensors, or data derived from the two or more processed tensors, are combined by means of a combination operation, obtaining a combined tensor that is output by the at least one first group of layers.

In one embodiment, at least one first group of layers of a neural network used as part of a data encoder and/or data decoder, such as an in-loop filter in a video encoder and/or video decoder, takes as input a first input tensor comprising a first spatial resolution and may comprise two or more second groups of layers that process respective two or more second input tensors, obtaining respective two or more processed tensors. The two or more processed tensors, or data derived from the two or more processed tensors, are combined by means of a combination operation, obtaining a combined tensor that is output by the at least one first group of layers. The two or more second input tensors may be derived from the first input tensor. At least one of the two or more second groups of layers, or at least one portion of at least one of the two or more second groups of layers, may process at least one of the two or more second input tensors, or another tensor that is derived from at least one of the two or more second input tensors, at a lower resolution than the first spatial resolution.

In one embodiment, a second group of layers of the two or more second groups of layers may comprise (but not be limited to) one or more of the following: a neural network layer (e.g., a convolutional neural network layer, a non-linear function), a skip or identity connection (e.g., summing a first tensor with a second tensor that is derived from the first tensor), a downsampling operation, an upsampling operation, a sum operation, and the like.

In one embodiment, the two or more second input tensors are the same or substantially the same as the first input tensor. In another embodiment, the two or more second input tensors are derived from the first input tensor and are different from the first input tensor. In another embodiment, two or more of the two or more second input tensors are different from each other. In yet another embodiment, one or more of the two or more second input tensors are same as the first input tensor and another one or more of the two or more second input tensors are derived from the first input tensor and are different from the first input tensor.

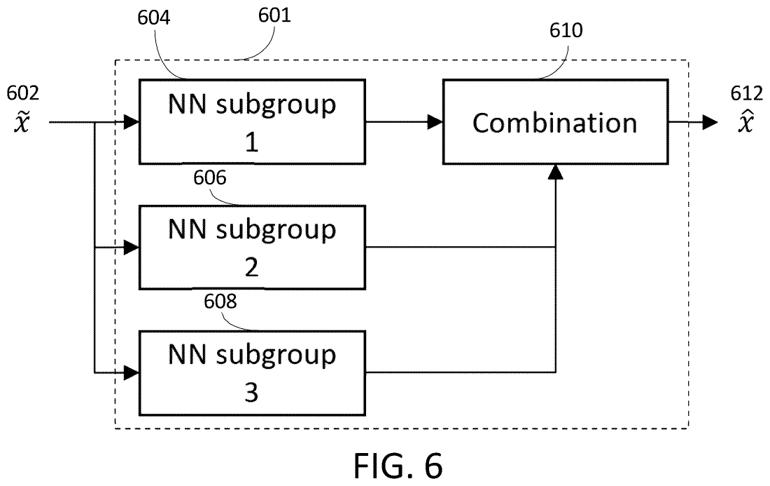

FIG. 6 illustrates an example of this embodiment. In particular, FIG. 6 illustrates one first group of layers 601 according to this embodiment.

In FIG. 6, \tilde{x} 602 represents the first input tensor, e.g., the input to the first group of layers 601. \hat{x} 612 represents the output of the first group of layers 601, e.g., the combined tensor 612. \tilde{x} 602 is provided as input to three second groups of layers “NN subgroup 1” 604, “NN subgroup 2” 606, “NN subgroup 3” 608. The outputs of these second groups are combined by means of a combination operation 610, obtaining \hat{x} 612.

In an embodiment, an apparatus includes at least one processor; and at least one memory storing instructions that, when executed by the at least one processor, cause the apparatus at least to: receive, with at least one first group of layers of a neural network used as part of a data encoder or data decoder, a first input tensor comprising a first spatial resolution; wherein the at least one first group of layers of the neural network comprises at least a portion of at least one group of at least one layer of two or more second groups of layers of the neural network, wherein the two or more second groups of layers of the neural network process respective two or more second input tensors to obtain respective two or more processed tensors, wherein the two or more second input tensors are derived from the first input tensor; and combine, using a combination operation, the two or more processed tensors, or data derived from the two or more processed tensors, to obtain a combined tensor that is output by the at least one first group of layers.

In one embodiment, the two or more second input tensors may comprise respective two or more different spatial resolutions and at least one of the two or more second input tensors may comprise a same resolution as the first input tensor. In one example, the resolution of one of the two or more second input tensors is same as the resolution of the first input tensor, and the resolution of another of the two or more second input tensors is lower from the resolution of the first input tensor, where the another of the two or more second input tensors is obtained by downsampling the first input tensor by using a downsampling factor (e.g., 2) or a target resolution.

In one embodiment, where the two or more second input tensors may comprise respective two or more spatial resolutions and at least one of the two or more second input tensors may comprise a same resolution as the first input tensor, at least one of the two or more processed tensors may be further processed to obtain respective one or more further processed tensors that comprise a spatial resolution that is equal to a resolution of at least another one of the two or more processed tensors or that is equal to a resolution of the first input tensor. In one example, where the resolution of a first processed tensor is same as the resolution of the first input tensor and the resolution of a second processed tensor is lower from the resolution of the first input tensor, the second processed tensor is upsampled by using an upsampling factor (e.g., 2) or a target resolution to obtain an upsampled second processed tensor that comprises a resolution that is same as the resolution of the first processed tensor.

In one embodiment, the two or more second input tensors may comprise respective two or more different spatial resolutions. In one example, the two or more second input tensors are obtained by downsampling the first input tensor by using respective two or more downsampling factors or respective two or more target resolutions, where the two or more downsampling factors are different or the two or more target resolutions are different.

In one embodiment, where the two or more second input tensors may comprise respective two or more spatial resolutions, the two or more processed tensors may be further processed to obtain respective two or more further processed tensors that comprise a same spatial resolution that is equal to the first spatial resolution of the first input tensor. In one example, the two or more processed tensors are upsampled by using respective two or more upsampling factors or a target resolution.

In one embodiment, where the two or more second input tensors may comprise respective two or more spatial resolutions, the two or more processed tensors may be further processed to obtain respective two or more further processed tensors that comprise a same spatial resolution that may be different from the first spatial resolution of the first input tensor. In one example, two second input tensors comprise respective two spatial resolutions which are different from a resolution of the first input tensor and are obtained by downsampling the first input tensor by using respective two downsampling factors (e.g., 2 and 4, respectively); the two second input tensors are processed by respective two second groups of layers, obtaining a first and a second processed tensors; the second processed tensor is upsampled by using an upsampling factor (e.g., 2) or a target resolution, obtaining an upsampled processed tensor that comprises a resolution that is same as a resolution comprised in the first processed tensor and that is different from a resolution of the first input tensor.

In one embodiment, downsampling operations and/or upsampling operations that are comprised in the at least one first group of layers are performed externally with respect to the two or more second groups of layers. In another embodiment, downsampling operations and/or upsampling operations that are comprised in the at least one first group of layers are comprised in at least one of the two or more second groups of layers.

In one embodiment, the two or more second groups of layers comprise a downsampling operation and/or an upsampling operation.

In one embodiment, at least one of the two or more second groups of layers comprises a downsampling operation and/or an upsampling operation.

In one example, the at least one first group of layers comprises two second groups of layers and performs the following operations:
downsample, using one of the two second groups of layers, the first input tensor based on a first downsampling factor to obtain a first downsampled tensor;
process, using one of the two second groups of layers, the first downsampled tensor to obtain a first processed tensor;
upsample, using the one of the two second groups of layers, the first processed tensor based on a first upsampling factor to obtain a first upsampled processed tensor;
downsample, using another of the two second groups of layers, the first input tensor based on a second downsampling factor to obtain a second downsampled tensor, wherein the second downsampling factor is higher than the first downsampling factor;
process, using the another of the two second groups of layers, the second downsampled tensor to obtain a second processed tensor;
upsample, using the another of the two second groups of layers, the second processed tensor based on a second upsampling factor to obtain a second upsampled processed tensor;
combine the first upsampled processed tensor and the second upsampled processed tensor by means of a combination operation to obtain an output of the at least one first group of layers.

In one embodiment, the two further processed tensors are combined by means of an element-wise sum operation. Alternatively, the two further processed tensors are combined by means of an element-wise multiplication operation. Alternatively, the two further processed tensors are combined by means of concatenating them along one of the axes or dimensions of the tensors, such as along the channel axis or dimension.

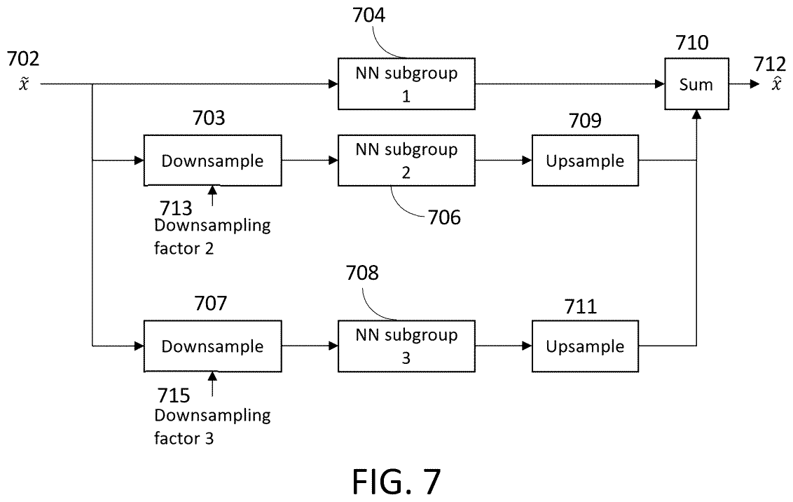

FIG. 7 illustrates an example of some of the previous embodiments.

In FIG. 7, the first input tensor x 702 is provided as input to a first subgroup of layers “NN subgroup 1” 704. Also, \tilde{x} 702 is provided as input to a “Downsample” operation 703 that downsamples \tilde{x} based on a downsampling factor “Downsampling factor 2” (713), which may be equal to 2. The downsampled tensor is provided as input to “NN subgroup 2” 706. The output of “NN subgroup 2” 706 is provided as input to “Upsample” 709 which upsamples its input to the same resolution as \tilde{x} 702. \tilde{x} 702 is also provided as input to another “Downsample” operation 707 that downsamples \tilde{x} based on a downsampling factor “Downsampling factor 3” (715), which may be equal to 4. The downsampled tensor is provided as input to “NN subgroup 3” 708. The output of “NN subgroup 3” is provided as input to “Upsample” 711 which upsamples its input to the same resolution as \tilde{x} 702. The output of “NN subgroup 1” 704 and the outputs of the two “Upsample” operations (709, 711) are combined by means of a sum operation 710 to obtain \hat{x} 712.

In one embodiment, the two or more second input tensors may comprise a same tensor, and the two or more second groups of layers process the respective two or more second input tensors based on respective two or more receptive fields. In one example, the two or more second groups of layers comprise respective two or more convolutional layers with respective two or more different kernel sizes. In another example, the two or more groups of layers comprise respective two or more convolutional layers with respective two or more different dilation rates.

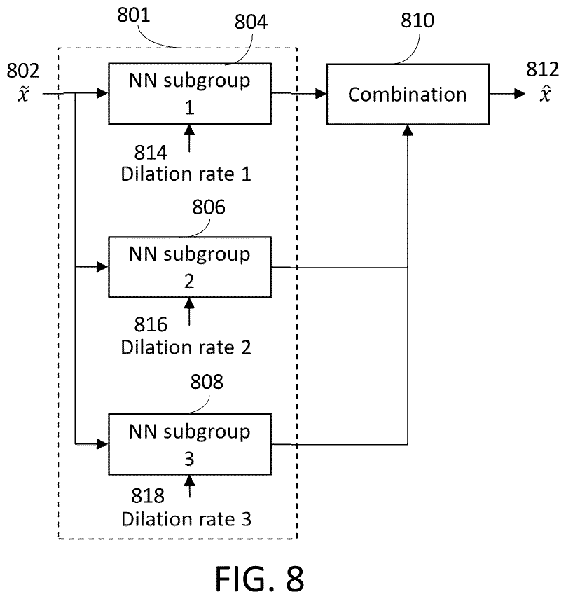

FIG. 8 illustrates an example of this embodiment.

In FIG. 8, a first group of layers 801 comprises three second groups of layers “NN subgroup 1” 804, “NN subgroup 2” 806 and “NN subgroup 3” 808, which comprise convolutional layers using different dilation rates. “NN subgroup 1” 804 uses dilation rate “Dilation rate 1” 814 which may be equal to 1, “NN subgroup 2” 806 uses dilation rate “Dilation rate 2” 816 which may be equal to 2, and “NN subgroup 3” 808 uses dilation rate “Dilation rate 3” 818 which may be equal to 3. It is to be noted that the dilation rates 814, 816, 818 may not need to be input to the second groups of layers; instead, the dilation rates may be comprised in the second groups of layers.

In FIG. 8, \tilde{x} 802 represents the first input tensor, e.g., the input to the first group of layers 801. \hat{x} 812 represents the output of the combination operation 810 that combines the output of NN subgroup 1 804, the output of NN subgroup 2 806, and the output of NN subgroup 3 808. \tilde{x} 802 is provided as input to “NN subgroup 1” 804, “NN subgroup 2” 806, and “NN subgroup 3” 808. Thus, the outputs of these subgroups are combined by means of the combination operation 810, obtaining \hat{x} 812.

In one embodiment, a neural network, such as a neural network based loop filter, may comprise two or more first groups of layers, where an input to at least one of the two or more first groups of layers comprises data that is derived from another of the two or more first groups of layers.

In one embodiment, a neural network (such as a neural network loop filter) may comprise two or more first groups of layers and may be used to process or filter a luma input and a chroma input to obtain a luma output and a chroma output or data from which a luma output is derived and data from which a chroma output is derived. One of the two of more first groups of layers may process a luma input, or data from which a luma output is derived, to obtain a processed luma. Another of the two or more first groups of layers may process a chroma input, or data from which a chroma output is derived, to obtain a processed chroma. The luma output is derived from the process luma and the chroma output is derived from the processed chroma.

In one embodiment, the two or more second groups of layers may comprise respective two or more values of a hyper-parameter that controls or affects a computational complexity metric and/or that controls or affects a number of parameters, where the two or more values may be different. In one example, the hyper-parameter is a number of channels or kernels of a convolutional neural network layer that is comprised in the two or more second groups of layers. In another example, the hyper-parameter is a size of one or more convolutional kernels comprised in a convolutional neural network layer that is comprised in the two or more second groups of layers. In one additional embodiment, a first value of the hyper-parameter for one of the two or more second groups of layers is higher than a second value of the hyper-parameter for another of the two or more second groups of layers. In one example, a first group of layers comprises two second groups of layers, where one of the two second groups of layers comprises a convolutional layer comprising C channels or kernels and another of the two second groups of layers comprises a downsampling operation followed by a convolutional layer comprising a number of channels or kernels higher than C followed by an upsampling operation. In another example, a first group of layers comprises two second groups of layers, where one of the two second groups of layers comprises a convolutional layer comprising a kernel size equal to K×K (e.g., K by K) and another of the two second groups of layers comprises a downsampling operation followed by a convolutional layer comprising a kernel size equal to D×D (e.g., D by D) where D is greater than K, followed by an upsampling operation. In yet another example, a first group of layers comprises two second groups of layers, where one of the two second groups of layers comprises a first spatial separable convolutional layer comprising an internal number of channels or kernels equal to C and another of the two second groups of layers comprises a downsampling operation followed by a second spatial separable convolutional layer comprising an internal number of channels or kernels higher than C followed by an upsampling operation, where the internal number of channels or kernels refers to the number of channels or kernels of the first of two cascaded convolutional layers that are comprised in a spatial separable convolutional layer. For example, a spatial separable convolutional layer comprises a first convolutional layer followed by a second convolutional layer, where the first convolutional layer comprises a first kernel size equal to 1×K (or 1 by K) and a first number of channels or kernels equal to C1, and where the second convolutional layer comprises a second kernel size equal to K×1 (or K by 1) and a second number of channels or kernels equal to C2; the internal number of channels or kernels is the first number of channels, e.g., C1.

In one embodiment, a downsampling or a downsampling operation may comprise (but may not be limited to) one or more of the following: a max-pooling neural network layer, an average pooling neural network layer, a global pooling neural network layer, a pixel unshuffle neural network layer, downsampling based on subpixel convolution (e.g., rearranging data from spatial dimension to depth or channel dimension), a convolutional neural network layer with a stride that is greater than 1 (may be also referred to as a strided convolutional layer), a convolutional neural network layer with a dilation rate that is greater than 1 (may be also referred to as a dilated convolutional layer), interpolation operation (e.g., by means of the nearest algorithm, or by means of the bilinear algorithm), a learned downsampling operation, a Fourier Transform based downsampling method.

In one embodiment, an upsampling or an upsampling operation may comprise (but may not be limited to) one or more of the following: interpolation-based upsampling (e.g., based on bilinear interpolation, or bicubic interpolation, or nearest-neighbor interpolation), pixel shuffle neural network layer, upsampling based on subpixel convolution (e.g., rearranging data from depth or channel dimension to spatial dimension), transpose convolutional neural network layer (may be also referred to as fractionally strided convolution), a learned upsampling operation, a learned interpolation, unpooling, a Fourier Transform based upsampling operation.

In one embodiment, a parameter may control whether one of the two or more second groups of layers is to be used, where an indication of the parameter may be received from an encoder or may be determined at a decoder side. In one example, the parameter may be a binary variable or a flag.

In one embodiment, a parameter may control which of the two or more second groups of layers is to be used, where an indication of the parameter may be received from an encoder or may be determined at a decoder side.

In one embodiment, when only one of the two or more second groups of layers is indicated to be used, the combination operation may be skipped or not performed, and the output of the first group of layers comprises an output of the one of the two or more second groups of layers that is indicated to be used.

In one embodiment, one or more parameters may control or modulate or modify respective one or more inputs to respective one or more of the two or more second groups of layers, where an indication of the one or more parameters may be received from an encoder or may be determined at a decoder side. In one example, the one or more parameters may comprise respective one or more multiplier values.

In one embodiment, one or more parameters may control or modulate or modify respective one or more outputs of respective one or more of the two or more second groups of layers, where an indication of the one or more parameters may be received from an encoder or may be determined at a decoder side. In one example, the one or more parameters may comprise respective one or more multiplier values.

The indication of the parameter may be signaled from an encoder to a decoder in or along a bitstream, such as within an Adaptation Parameter Set, where the decoder comprises a neural network that comprises the first group of layers.

The parameter or the indication of the parameter may be determined at decoder side based on a resolution of an input to the neural network that comprises the first group of layers. In one example, if the resolution of an input to the neural network is lower than a threshold, only a subset of the two or more second groups of layers will be used. In another example, if the resolution of an input to the neural network is higher than a threshold, all the two or more second groups of layers will be used.

The parameters or the indication of the parameter may be determined at decoder side based on an available computational budget or based on a computational complexity threshold. In one example, if the available computational budget is lower than a threshold (e.g., the neural network can comprise a computational complexity lower than a threshold), a subset of the two or more second groups of layers will be used, such as those whose inputs are of lower resolution.

In some of the previous embodiments, the parameter may comprise a number S of second groups of layers to use, where the two or more second groups are assumed to be ordered according to an order, where the order may be predetermined or received from an encoder or derived at a decoder side. One or more of the two or more second groups of layers may be selected to be used based on the number S and on the order, such as by selecting the first S second groups of layers from an ordered list of the two or more second groups of layers, where the ordered list was obtained based on the order. The order may be such that the two or more second groups of layers are ordered based on the resolution of their respective input tensors, such as from high resolution to low resolution. In one example, the first group of layers comprises three second groups of layers, where the respective three inputs to the three second groups of layers comprise respective three different resolutions; the number S is equal to 2; the three second groups of layers are ordered based on descending resolution of their input; two second groups of layers whose inputs have the lowest resolution are selected from the three second groups of layers.

### Example

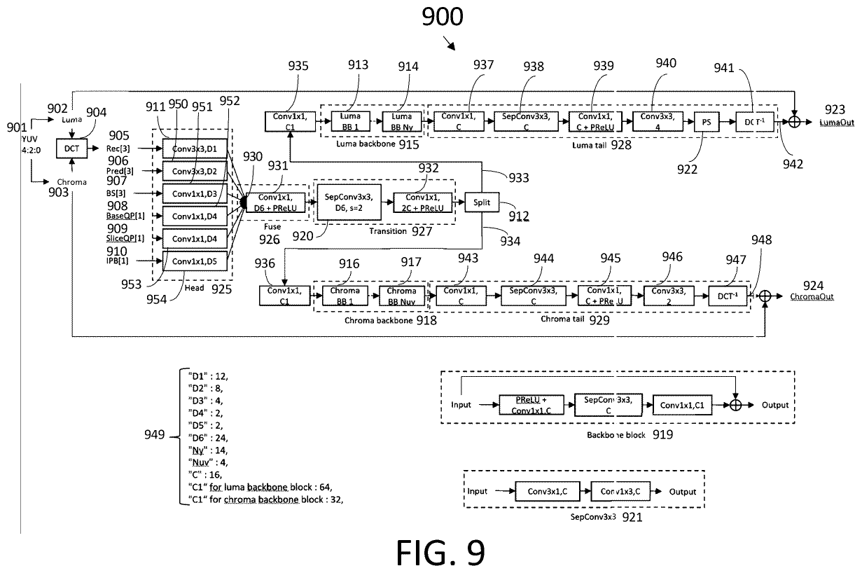

FIG. 9 shows an example architecture of a NN filter 900, which is considered in order to provide further examples of the herein described embodiments. The NN filter 900 may be an in-loop filter of a video encoder or video decoder. The goal of the NN filter 900 may be to filter or enhance the quality of intermediate data of a decoding process, such as reconstructed luma and chroma data.

In FIG. 9, “luma” 902 and “chroma” 903 refer to the reconstructed luma and chroma that are to be enhanced by the NN filter 900, and may represent an intermediate result of an encoding or decoding operation. In one example, where the filter is a loop filter of a video codec, “luma” 902 and “chroma” 903 may represent the result of combining a predicted block with a decoded residual. The luma 902 and chroma 903, that may be extracted from a YUV420 signal 901, are provided as input to a Discrete Cosine Transform (DCT) 904, obtaining DCT-transformed luma and DCT-transformed chroma that are then concatenated to form the reconstruction Rec 905.

The terms Rec 905, Pred 906, BS 907, BaseQP 908, SliceQP 909, IPB 910 represent the inputs to the NN filter 900 and each of those inputs is usually in the format of a tensor of shape B×C×H×W, where B indicates a batch size (e.g., number of pictures or blocks), C indicates a number of channels, H and W indicate a height and width, respectively. The square brackets and the number within them (e.g., Rec[3]), indicate the number of channels of the associated tensor. For example, Rec[3] indicates that the input tensor Rec 905 contains 3 channels, thus has shape B×3×H×W, where the 3 channels may represent the luma channel, the Blue-Yellow Chrominance (Cb) channel and the Red-Green Chrominance (Cr) channel. The Cb channel and the Cr channel may be collectively referred to as chroma.

Pred 906 refers to prediction. BS 907 refers to boundary strength, BaseQP 908 refers to the sequence-level quantization parameter (QP), SliceQP 909 refers to the slice-level QP, IPB 910 refers to the type of slice or type of picture (e.g., intra slice, P inter slice, B inter slice).

In some embodiments, Rec 905 may be referred to as main input, or data to be filtered, whereas Pred 906, BS 907, BaseQP 908, SliceQP 909 and IPB 910 may be referred to as auxiliary input, or data not to be filtered.

Each block in FIG. 9 represents an operation, such as one or more NN layers. The block “ConvK1×K2,Z” (in general, such as block 911) indicates a convolutional layer with kernel size K1×K2 and number of kernels equal to Z. When present, the term “+PRELU” indicates that a layer is followed by a Parameterized Rectified Linear Unit (PRELU). When present, the term “PRELU+” indicates that a layer is preceded by a Parameterized Rectified Linear Unit (PRELU). When present, the term “s=2” indicates that a convolutional layer has stride equal to 2; when not present, the convolutional layer has stride equal to 1. “Split” 912 refers to an operation that splits a tensor across the channel dimension. “Luma BB” (such as items 913 and 914 that together implement luma backbone 915) and “Chroma BB” (such as items 916 and 917 that together implement chroma backbone 918) indicate a backbone block used for filtering or processing the luma channel and the chroma channel, respectively; the architecture of a backbone block in general is also shown in FIG. 9 as item 919, and comprises several layers and operations. “SepConv3×3” indicates a block (such as item 920) that comprises a separable convolution; an illustration of the SepConv3×3 block is also shown in FIG. 9 in general as item 921 and it comprises several layers. “PS” refers to a Pixel Shuffle operation (such as operation 922), which rearranges elements in a tensor of shape B×(C*r*r)×H×W to a tensor of shape B×C×(H*r)×(W*r), where r is an upscale factor. “LumaOut” 923 and “ChromaOut” 924 represent the filtered luma and the filtered chroma, respectively, i.e., the final outputs from the NN filter 900.

For the sake of simplicity, the NN architecture is figuratively organized into the following sections: head 925, fuse 926, transition 927, luma backbone 915, chroma backbone 918, luma tail 928, chroma tail 929. However, it is to be noted that other possible organizations of the NN 900 into subsets or blocks or sections may be possible and may still be in the scope of this description.

All the input tensors are input to respective convolutional layers that are part of the “head” section 925 of the NN filter 900. As shown in FIG. 9, Rec 905 is input to convolutional layer 911, Pred 906 is input to convolutional layer 950, BS 907 is input to convolutional layer 951, BaseQP 908 is input to convolutional layer 952, SliceQP 909 is input to convolutional layer 953, and IPB 910 is input to convolutional layer 954. The outputs of those convolutional layers are tensors, referred to head tensors. As part of the operations of the “fuse” section 926 of the NN, the head tensors are concatenated into a single tensor across the channel dimension (the concatenation operation is not illustrated in FIG. 9). The concatenated tensor 930 is input to a convolutional layer, followed by a non-linear activation function PreLU (collectively item 931). The output of the fuse section 926 is input to the “transition” section 927 of the NN 900, which comprises a separable convolutional layer with stride equal to 2 (920) and a convolutional layer and a PRELU layer (collectively 932). The output of the transition section 927 is a tensor of shape Bx(2*C)×(H/2)×(W/2), and it's split 912 into two sub-tensors, where each subtensor is of shape B×C×(H/2)×(W/2). A first subtensor 933 is used to filter the luma and a second subtensor 934 is used to filter the chroma. The first subtensor 933 is input to a convolutional layer 935 that maps the number of channel C to a different number of channels, followed by the “luma backbone” section 915, and the second subtensor 934 is input to a convolutional layer 936 that maps the number of channel C to a different number of channels, followed by the “chroma backbone” section 918. The luma backbone section 915 comprises Ny luma backbone blocks (some or all of which are depicted in FIG. 9 as Luma BB 1 913 and Luma BB Ny 914), and the chroma backbone section 918 comprises Nuv chroma backbone blocks (some or all of which are depicted in FIG. 9 as Chroma BB 1 916 and Chroma BB Nuv 917). The output of a backbone block is input to the next backbone block, until the last backbone block in the section. For example, the output of Luma BB1 913 is input to Luma BB Ny 914, and the output of Chroma BB 1 916 is input to Chroma BB Nuv 917. The output of the last luma backbone block 914 is input to the “luma tail” section 928, that comprises a 1×1 convolutional layer 937, a separable convolution SepConv3×3 938, another 1×1 convolutional layer 939, a PRELU operation (of item 939), a Conv3×3 layer 940, a Pixel Shuffle operation 922, and an inverse DCT operation 941. The output 942 of the PixelShuffle operation 922 is added to the input luma 902, in order to obtain LumaOut 923. The output of the last chroma backbone block 917 is input to the “chroma tail” section 929, that comprises a 1×1 convolutional layer 943, a separable convolution SepConv3×3 944, another 1×1 convolutional layer 945, a PRELU operation (of item 945), a Conv3×3 layer 946, and an inverse DCT operation 947. The output 948 of the inverse DCT operation 947 is added to the input chroma 903, in order to obtain ChromaOut 924.

In FIG. 9, also examples of the values of various hyper-parameters of the NN are indicated at 949, such as the number of channels of convolutional layers, D1, D2, D3, D4, D5, D6, C, C1, the number of luma and chroma backbone blocks Ny and Nuv.

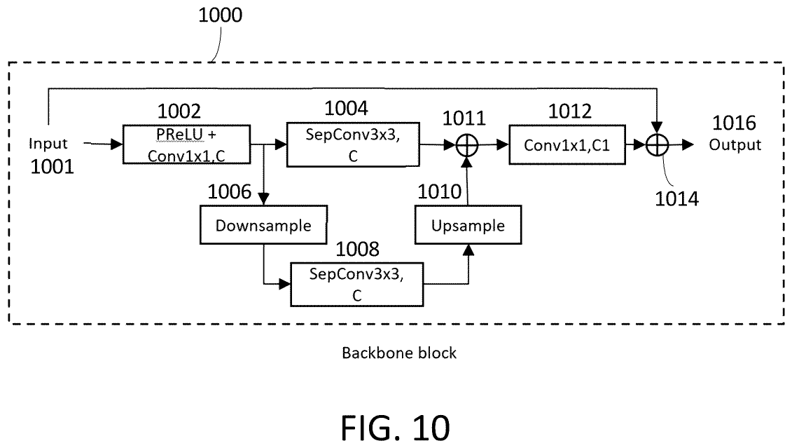

FIG. 10 illustrates an example of a modified backbone block 1000 for the example NN filter architecture 900 described with reference to FIG. 9, according to some of the present embodiments.

In FIG. 10, an input 1001 may comprise an input tensor and is provided as input to the modified backbone block 1000. The input 1001 is input to a 1×1 convolutional layer 1002, obtaining an output of the 1×1 convolutional layer 1002. The output of the 1×1 convolutional layer 1002 is provided to a first separable convolution 1004 and is also downsampled 1006, e.g., by a factor of 2 in both spatial dimensions. The downsampled data is provided to a second separable convolution 1008. The output of the second separable convolution 1008 is upsampled 1010 to the same resolution as the output of the first separable convolution 1004, e.g., by a factor of 2. The output of the first separable convolution 1004 and the upsampled data are summed by means of a first sum operation 1011, obtaining a combined tensor. The combined tensor is provided to another 1×1 convolutional layer 1012. The output of the another 1×1 convolutional layer 1012 is summed 1014 with the input 1001 to the modified backbone block 1000, obtaining the output 1016 of the modified backbone block.

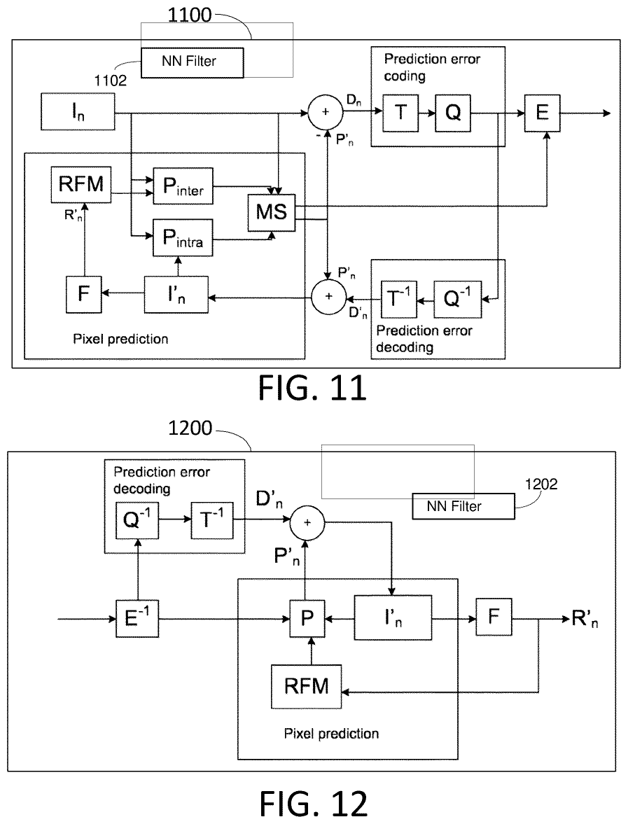

FIG. 11 shows an encoder 1100 according to an embodiment. FIG. 11 illustrates an image to be encoded (Iⁿ), a predicted representation of an image block (P′ⁿ), a prediction error signal (Dⁿ), a reconstructed prediction error signal (D′ⁿ), a preliminary reconstructed image (I′ⁿ), a final reconstructed image (R′ⁿ), a transform (T) and inverse transform (T⁻¹), a quantization (Q) and inverse quantization (Q⁻¹), entropy encoding (E), a reference frame memory (RFM), inter prediction (P^{inter}), intra prediction (P^{intra}), mode selection (MS) and filtering (F). NN filter 1102 implements an NN filter, and the examples described herein related to multi-scale blocks for neural network based filters.

FIG. 12 shows a decoder 1200 according to an embodiment. FIG. 12 illustrates a predicted representation of an image block (P′ⁿ), a reconstructed prediction error signal (D′ⁿ), a preliminary reconstructed image (I′ⁿ), a final reconstructed image (R′ⁿ), an inverse transform (T⁻¹), an inverse quantization (Q⁻¹), an entropy decoding (E¹), a reference frame memory (RFM), a prediction (either inter or intra) (P), and filtering (F). NN filter 1202 implements an NN filter, and the examples described herein related to multi-scale blocks for neural network based filters.

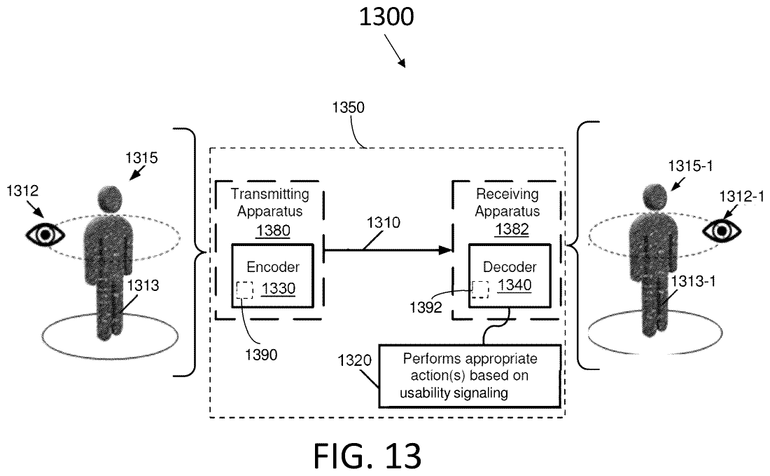

FIG. 13 is a block diagram illustrating a system 1300 in accordance with several examples. In an example, the encoder 1330 is used to encode an image or video from the scene 1315, and the encoder 1330 is implemented in a transmitting apparatus 1380. The encoder 1330 produces a bitstream 1310 comprising signaling that is received by the receiving apparatus 1382, which implements a decoder 1340. The encoder 1330 sends the bitstream 1310 that comprises the herein described signaling. The decoder 1340 forms the image or video for the scene 1315-1, and the receiving apparatus 1382 would present this to the user, e.g., via a smartphone, television, or projector among many other options.

In some examples, the transmitting apparatus 1380 and the receiving apparatus 1382 are at least partially within a common apparatus, and for example are located within a common housing 1350. In other examples the transmitting apparatus 1380 and the receiving apparatus 1382 are at least partially not within a common apparatus and have at least partially different housings. Therefore in some examples, the encoder 1330 and the decoder 1340 are at least partially within a common apparatus, and for example are located within a common housing 1350. For example the common apparatus comprising the encoder 1330 and decoder 1340 implements a codec. In other examples the encoder 1330 and the decoder 1340 are at least partially not within a common apparatus and have at least partially different housings, but when together still implement a codec.

In some examples, 3D media from the capture (e.g., volumetric capture) at a viewpoint 1312 of the scene 1315, which includes a person 1313) is converted via projection to a series of 2D representations with occupancy, geometry, attributes and/or displacements. Additional atlas information is also included in the bitstream to enable inverse reconstruction. For decoding, the received bitstream 1310 is separated into its components with atlas information; occupancy, geometry, displacement, and attribute 2D representations. A 3D reconstruction is performed to reconstruct the scene 1315-1 created looking at the viewpoint 1312-1 with a “reconstructed” person 1313-1. The “−1” are used to indicate that these are reconstructions of the original. As indicated at 1320, the decoder 1340 performs an action or actions based on the received signaling.

Encoding 1390 performs the encoding-side examples described herein related to multi-scale blocks for neural network based filters. Decoding 1392 performs the decoding-side examples described herein related to multi-scale blocks for neural network based filters.

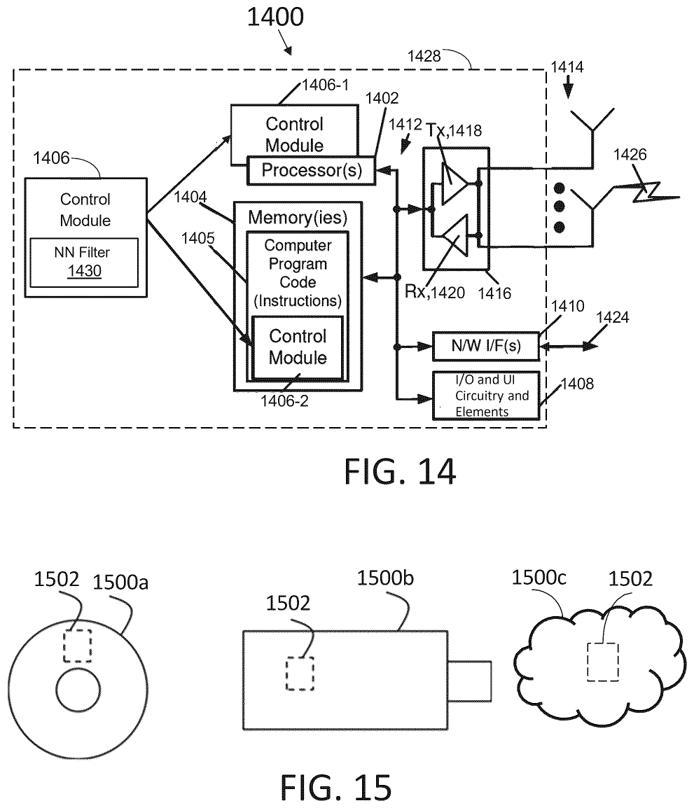

FIG. 14 is an example apparatus 1400, which may be implemented in hardware, configured to implement the examples described herein. The apparatus 1400 comprises at least one processor 1402 (e.g., an FPGA and/or CPU and/or GPU), one or more memories 1404 including computer program code 1405, the computer program code 1405 having instructions to carry out the methods described herein, wherein the at least one memory 1404 and the computer program code 1405 are configured to, with the at least one processor 1402, cause the apparatus 1400 to implement circuitry, a process, component, module, or function (implemented with control module 1406) to implement the examples described herein.

Apparatus 1400 may be a smartphone, personal digital device or assistant, smart television, laptop, pad, tablet, head-mounted display (HMD), or other user device or terminal device. The memory 1404 may be a non-transitory memory, a transitory memory, a volatile memory (e.g. RAM), or a non-volatile memory (e.g., ROM).

NN filter 1430 implements an NN filter, and the examples described herein related to multi-scale blocks for neural network based filters.

The apparatus 1400 includes a display and/or I/O interface 1408, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 1400 includes one or more communication e.g. network (N/W) interfaces (I/F(s)) 1410. The communication I/F(s) 1410 may be wired and/or wireless and communicate over the Internet/other network(s) via any communication technique including via one or more links 1424. The communication I/F(s) 1410 may comprise one or more transmitters or one or more receivers.

The transceiver 1416 comprises one or more transmitters 1418 and one or more receivers 1420. The transceiver 1416 and/or communication I/F(s) 1410 may comprise standard well-known components such as an amplifier, filter, frequency-converter, (de) modulator, and encoder/decoder circuitries and one or more antennas, such as antennas 1414 used for communication over wireless link 1426.

The control module 1406 of the apparatus 1400 comprises one of or both parts 1406-1 and/or 1406-2, which may be implemented in a number of ways. The control module 1406 may be implemented in hardware as control module 1406-1, such as being implemented as part of the one or more processors 1402. The control module 1406-1 may be implemented also as an integrated circuit or through other hardware such as a programmable gate array. In another example, the control module 1406 may be implemented as control module 1406-2, which is implemented as computer program code (having corresponding instructions) 1405 and is executed by the one or more processors 1402. For instance, the one or more memories 1404 store instructions that, when executed by the one or more processors 1402, cause the apparatus 1400 to perform one or more of the operations as described herein. Furthermore, the one or more processors 1402, one or more memories 1404, and example algorithms (e.g., as flowcharts and/or signaling diagrams), encoded as instructions, programs, or code, are means for causing performance of the operations described herein.

The apparatus 1400 to implement the functionality of control 1406 may correspond to any of the apparatuses depicted herein. Alternatively, apparatus 1400 and its elements may not correspond to any of the other apparatuses depicted herein, as apparatus 1400 may be part of a self-organizing/optimizing network (SON) node or other node, such as a node in a cloud.

The apparatus 1400 may also be distributed throughout the network including within and between apparatus 1400 and any network element (such as a base station and/or terminal device and/or user equipment).

Interface 1412 enables data communication and signaling between the various items of apparatus 1400, as shown in FIG. 14. For example, the interface 1412 may be one or more buses such as address, data, or control buses, and may include any interconnection mechanism, such as a series of lines on a motherboard or integrated circuit, fiber optics or other optical communication equipment, and the like. Computer program code (e.g. instructions) 1405, including control 1406 may comprise object-oriented software configured to pass data or messages between objects within computer program code 1405. Computer program code (e.g. instructions) 1405, including control 1406 may comprise procedural, functional, or scripting code. The apparatus 1400 need not comprise each of the features mentioned, or may comprise other features as well. The various components of apparatus 1400 may at least partially reside in a common housing 1428, or a subset of the various components of apparatus 1400 may at least partially be located in different housings, which different housings may include housing 1428.

FIG. 15 shows a schematic representation of non-volatile memory media 1500a (e.g. computer/compact disc (CD) or digital versatile disc (DVD)) and 1500b (e.g. universal serial bus (USB) memory stick) and 1500c (e.g. cloud storage for downloading instructions and/or parameters 1502 or receiving emailed instructions and/or parameters 1502) storing instructions and/or parameters 1502 which when executed by a processor allows the processor to perform one or more of the operations of the methods described herein. Instructions and/or parameters 1502 may represent or correspond to a non-transitory computer readable medium.

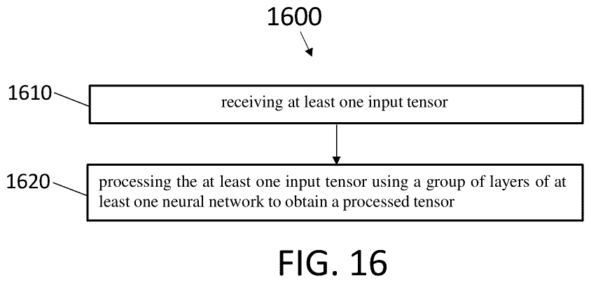

FIG. 16 is an example method 1600, based on the examples described herein. At 1610, the method includes receiving at least one input tensor. At 1620, the method includes processing the at least one input tensor using a group of layers of at least one neural network to obtain a processed tensor. Method 1600 may be performed with any of the apparatuses described herein, including NN filter 900, encoder 1100 with NN filter 1102, decoder 1200 with NN filter 1200, transmitting apparatus with encoding 1390, receiving apparatus with decoding 1392, or apparatus 1400 with NN filter 1430.

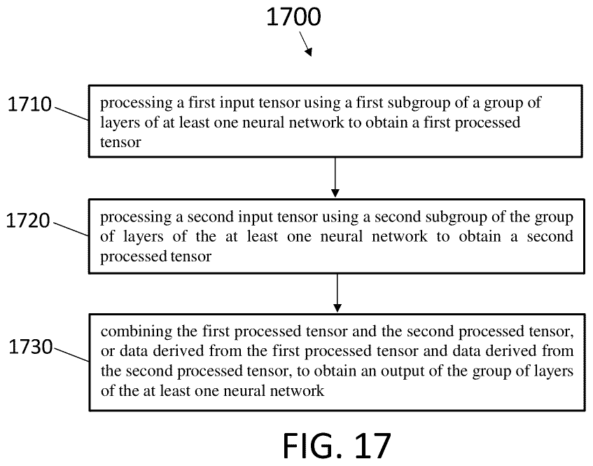

FIG. 17 is an example method 1700, based on the examples described herein. At 1710, the method includes processing a first input tensor using a first subgroup of a group of layers of at least one neural network to obtain a first processed tensor. At 1720, the method includes processing a second input tensor using a second subgroup of the group of layers of the at least one neural network to obtain a second processed tensor. At 1730, the method includes combining the first processed tensor and the second processed tensor, or data derived from the first processed tensor and data derived from the second processed tensor, to obtain an output of the group of layers of the at least one neural network. Method 1700 may be performed with any of the apparatuses described herein, including NN filter 900, encoder 1100 with NN filter 1102, decoder 1200 with NN filter 1200, transmitting apparatus with encoding 1390, receiving apparatus with decoding 1392, or apparatus 1400 with NN filter 1430.

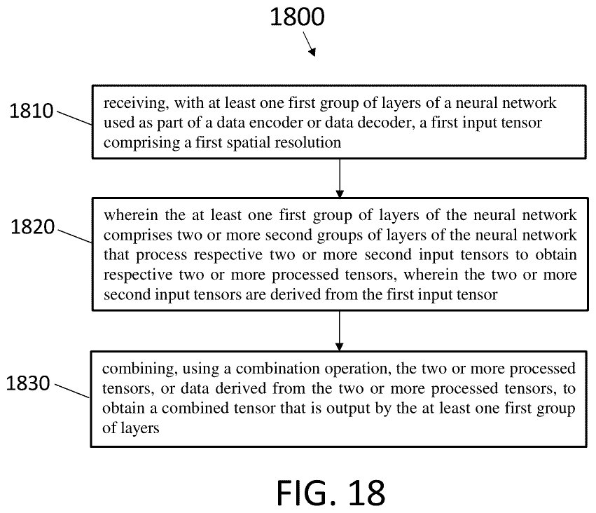

FIG. 18 is an example method 1800, based on the examples described herein. At 1810, the method includes receiving, with at least one first group of layers of a neural network used as part of a data encoder or data decoder, a first input tensor comprising a first spatial resolution. At 1820, the method includes wherein the at least one first group of layers of the neural network comprises two or more second groups of layers of the neural network that process respective two or more second input tensors to obtain respective two or more processed tensors, wherein the two or more second input tensors are derived from the first input tensor. At 1830, the method includes combining, using a combination operation, the two or more processed tensors, or data derived from the two or more processed tensors, to obtain a combined tensor that is output by the at least one first group of layers. Method 1800 may be performed with any of the apparatuses described herein, including NN filter 900, encoder 1100 with NN filter 1102, decoder 1200 with NN filter 1200, transmitting apparatus with encoding 1390, receiving apparatus with decoding 1392, or apparatus 1400 with NN filter 1430.

The following examples are provided and described herein.

Example 1. An apparatus including: at least one processor; and at least one memory storing instructions that, when executed by the at least one processor, cause the apparatus at least to: receive at least one input tensor; and process the at least one input tensor using a group of layers of at least one neural network to obtain a processed tensor.

Example 2. The apparatus of example 1, wherein the apparatus is further caused to: process a first input tensor using a first subgroup of the group of layers of the at least one neural network to obtain a first processed tensor; process a second input tensor using a second subgroup of the group of layers of the at least one neural network to obtain a second processed tensor; and combine the first processed tensor and the second processed tensor, or data derived from the first processed tensor and data derived from the second processed tensor, to obtain an output of the group of layers of the at least one neural network; wherein the processed tensor comprises the output of the group of layers of the at least one neural network.

Example 3. The apparatus of example 2, wherein the first input tensor that is processed using the first subgroup of the group of layers of the at least one neural network is the same as the second input tensor that is processed using the second subgroup of the group of layers of the at least one neural network.

Example 4. The apparatus of any of examples 2 to 3, wherein the first input tensor that is processed using the first subgroup of the group of layers of the at least one neural network is different from the second input tensor that is processed using the second subgroup of the group of layers of the at least one neural network.

Example 5. The apparatus of any of examples 2 to 4, wherein at least one of: the first input tensor that is processed using the first subgroup of the group of layers of the at least one neural network is the same as the at least one input tensor, or the second input tensor that is processed using the second subgroup of the group of layers of the at least one neural network is the same as the at least one input tensor.

Example 6. The apparatus of any of examples 2 to 5, wherein at least one of: the first input tensor that is processed using the first subgroup of the group of layers of the at least one neural network is different from the at least one input tensor and is derived from the at least one input tensor, or the second input tensor that is processed using the second subgroup of the group of layers of the at least one neural network is different from the at least one input tensor and is derived from the at least one input tensor.

Example 7. The apparatus of any of examples 2 to 6, wherein the apparatus is further caused to: downsample, using the first subgroup of the group of layers of the at least one neural network, the first input tensor that is processed using the first subgroup of the group of layers of the at least one neural network based on a first downsampling factor to obtain a first downsampled tensor; process, using the first subgroup of the group of layers of the at least one neural network, the first downsampled tensor to obtain an initial first processed tensor; upsample, using the first subgroup of the group of layers of the at least one neural network, the initial first processed tensor based on a first upsampling factor to obtain the first processed tensor; downsample, using the second subgroup of the group of layers of the at least one neural network, the second input tensor that is processed using the second subgroup of the group of layers of the at least one neural network based on a second downsampling factor to obtain a second downsampled tensor; wherein the second downsampling factor is greater than the first downsampling factor; process, using the second subgroup of the group of layers of the at least one neural network, the second downsampled tensor to obtain an initial second processed tensor; and upsample, using the second subgroup of the group of layers of the at least one neural network, the initial second processed tensor based on a second upsampling factor to obtain the second processed tensor.

Example 8. The apparatus of any of examples 2 to 7, wherein the apparatus is further caused to: downsample the second input tensor that is processed using the second subgroup of the group of layers of the at least one neural network based on a downsampling factor to obtain a downsampled input tensor; process the downsampled input tensor using the second subgroup of the group of layers of the at least one neural network to obtain an initial second processed tensor; and upsample, using the second subgroup of the group of layers of the at least one neural network, the initial second processed tensor based on an upsampling factor to obtain the second processed tensor.

Example 9. The apparatus of example 7 or example 8, wherein the apparatus is further caused to: upsample the initial second processed tensor so that a resolution of the second processed tensor is the same as a resolution of the at least one input tensor or is the same as a resolution of the first processed tensor.

Example 10. The apparatus of example 9, wherein the apparatus is further caused to: downsample a third input tensor that is processed using a third subgroup of the group of layers of the at least one neural network based on another downsampling factor to obtain another downsampled input tensor; wherein the another downsampling factor that is used to downsample the third input tensor that is processed using the third subgroup of the group of layers of the at least one neural network is greater than the downsampling factor that is used to downsample the second input tensor that is processed using the second subgroup of the group of layers of the at least one neural network; process the another downsampled input tensor using the third subgroup of the group of layers of the at least one neural network to obtain a third processed tensor; upsample the third processed tensor based on another upsampling factor to obtain a third processed tensor, so that a resolution of the third processed tensor is the same as a resolution of the at least one input tensor or is the same as a resolution of the first processed tensor; and combine the third processed tensor, the second processed tensor, and the first processed tensor to obtain the output of the group of layers of the at least one neural network, wherein the processed tensor comprises the output of the group of layers of the at least one neural network.

Example 11. The apparatus of any of examples 2 to 10, wherein: the first subgroup of the group of layers of the at least one neural network comprises convolutional layers using a first dilation rate, and the second subgroup of the group of layers of the at least one neural network comprises convolutional layers using a second dilation rate that is different from the first dilation rate.

Example 12. The apparatus of any of examples 1 to 11, wherein the apparatus is further caused to: process a luma input, or data from which a luma output is derived, using at least one or more first instances of the group of layers of the at least one neural network to obtain a processed luma; process a chroma input, or data from which a chroma output is derived, using at least one or more second instances of the group of layers of the at least one neural network to obtain a processed chroma; and derive the luma output based on the processed luma and derive the chroma output based on the processed chroma.

Example 13. The apparatus of any of examples 2 to 12, wherein the apparatus is further caused to: process an input tensor using a first convolutional neural network layer to generate an output of the first convolutional neural network layer, wherein the at least one input tensor comprises the output of the first convolutional neural network layer; process the output of the first convolutional neural network layer using a first separable convolutional neural network layer to obtain an output of the first separable convolutional neural network layer, wherein the first subgroup of the group of layers comprises the first separable convolutional neural network layer and wherein the first processed tensor comprises the output of the first separable convolutional neural network layer; downsample the output of the first convolutional neural network layer using a downsampling operation to obtain a downsampled output of the first convolutional neural network layer; process the downsampled output of the first convolutional neural network layer using a second separable convolutional neural network layer to obtain an output of the second separable convolutional neural network layer, wherein the second subgroup of the group of layers comprises the second separable convolutional neural network layer and wherein the second processed tensor comprises the output of the second separable convolutional neural network layer; upsample the output of the second separable convolutional neural network layer using an upsampling operation to obtain an upsampled output of the second separable convolutional neural network layer, so that the upsampled output of the second separable convolutional neural network layer has the same resolution as the output of the first separable convolutional neural network layer; sum, using a first summing operation, the output of the first separable convolutional neural network layer and the upsampled output of the second separable convolutional neural network layer to obtain a summed output; process the summed output the using a second convolutional neural network layer to obtain an output of the second convolutional neural network layer; and sum, using a second summing operation, the output of the second convolutional neural network layer with the luma input or the chroma input to obtain an output tensor.

Example 14. The apparatus of example 13, wherein the input tensor comprises at least one of a luma input, a chroma input, data from which luma data is derived, or data from which chroma data is derived.

Example 15. The apparatus of any of examples 13 to 14, wherein the group of layers of the at least one neural network comprises: the first separable convolutional neural network layer, the downsampling operation, the second separable convolutional neural network layer, the upsampling operation, and the first summing operation.

Example 16. The apparatus of any of examples 13 to 15, wherein the at least one input tensor comprises the output of the first convolutional neural network layer.

Example 17. The apparatus of any of examples 13 to 16, wherein the processed tensor comprises the summed output.

Example 18. The apparatus of any of examples 1 to 17, wherein the apparatus is further caused to: process the at least one input tensor using a first subgroup of the group of layers of the at least one neural network to obtain a first processed tensor; and downsample the at least one input tensor using a downsampling operation based on a downsampling factor to obtain a downsampled input tensor; process the downsampled input tensor using a second subgroup of the group of layers to obtain a second processed tensor; upsample the second processed tensor using an upsampling operation based on an upsampling factor to obtain an upsampled processed tensor, such that the upsampled processed tensor has the same resolution as the at least one input tensor processed using the first subgroup or the first processed tensor; combine the first processed tensor and the upsampled processed tensor to obtain an output of the group of layers of the at least one neural network, wherein the processed tensor comprises the output of the group of layers of the at least one neural network.

Example 19. The apparatus of any of examples 1 to 18, wherein the apparatus is further caused to: process the at least one input tensor using a first subgroup of the group of layers of the at least one neural network to obtain a first processed tensor; downsample the at least one input tensor using a second subgroup of the group of layers of the at least one neural network based on a downsampling factor to obtain an initial second processed tensor; process, using the second subgroup of the group of layers of the at least one neural network, the initial second processed tensor to obtain a second processed tensor; upsample the second processed tensor using the second subgroup of the group of layers of the at least one neural network based on an upsampling factor to obtain an upsampled processed tensor, such that the upsampled processed tensor has the same resolution as the at least one input tensor processed using the first subgroup or the first processed tensor; combine the first processed tensor and the upsampled processed tensor to obtain an output of the group of layers of the at least one neural network, wherein the processed tensor comprises the output of the group of layers of the at least one neural network.

Example 20. The apparatus of any of examples 1 to 19, wherein the apparatus is further caused to: downsample the at least one input tensor using a downsampling operation based on a first downsampling factor to obtain a first downsampled input tensor; process the first downsampled input tensor using a first subgroup of the group of layers of the at least one neural network to obtain a first processed tensor; upsample the first processed tensor using an upsampling operation to obtain a first upsampled processed tensor that has the same resolution as the at least one input tensor that is downsampled based on the first downsampling factor; downsample the at least one input tensor using the downsampling operation based on a second downsampling factor to obtain a second downsampled input tensor; wherein the second downsampling factor is greater than the first downsampling factor; process the second downsampled input tensor using a second subgroup of the group of layers of the at least one neural network to obtain a second processed tensor; upsample the second processed tensor using the upsampling operation to obtain a second upsampled processed tensor that has the same resolution as the at least one input tensor that is downsampled based on the second downsampling factor or that has the same resolution as the first upsampled processed tensor; and combine the first upsampled processed tensor and the second upsampled processed tensor to obtain an output of the group of layers of the at least one neural network, wherein the processed tensor comprises the output of the group of layers of the at least one neural network.

Example 21. The apparatus of any of examples 1 to 20, wherein the apparatus is further caused to: downsample the at least one input tensor using a first subgroup of the group of layers of the at least one neural network based on a first downsampling factor to obtain an initial first processed tensor; process, using the first subgroup of the group of layers of the at least one neural network, the initial first processed tensor to obtain a first processed tensor; upsample the first processed tensor using the first subgroup of the group of layers of the at least one neural network to obtain a first upsampled processed tensor that has the same resolution as the at least one input tensor that is downsampled based on the first downsampling factor; downsample the at least one input tensor using a second subgroup of the group of layers of the at least one neural network based on a second downsampling factor to obtain an initial second processed tensor; process, using the second subgroup of the group of layers of the at least one neural network, the initial second processed tensor to obtain a second processed tensor; wherein the second downsampling factor is greater than the first downsampling factor; upsample the second processed tensor using the second subgroup of the group of layers of the at least one neural network to obtain a second upsampled processed tensor that has the same resolution as the at least one input tensor that is downsampled based on the second downsampling factor; and combine the first upsampled processed tensor and the second upsampled processed tensor to obtain an output of the group of layers of the at least one neural network, wherein the processed tensor comprises the output of the group of layers of the at least one neural network.

Example 22. The apparatus of any of examples 1 to 21, wherein the apparatus is further caused to: downsample the at least one input tensor using a downsampling operation based on a first downsampling factor to obtain a first downsampled input tensor; process the first downsampled input tensor using a first subgroup of the group of layers of the at least one neural network to obtain a first processed tensor; upsample the first processed tensor using an upsampling operation to obtain a first upsampled processed tensor that has the same resolution as the at least one input tensor that is downsampled based on the first downsampling factor; downsample the at least one input tensor using a second subgroup of the group of layers of the at least one neural network based on a second downsampling factor to obtain an initial second processed tensor; wherein the second downsampling factor is greater than the first downsampling factor; process, using the second subgroup of the group of layers of the at least one neural network, the initial second processed tensor to obtain a second processed tensor; upsample the second processed tensor using the second subgroup of the group of layers of the at least one neural network to obtain a second upsampled processed tensor that has the same resolution as the at least one input tensor that is downsampled based on the second downsampling factor; and combine the first upsampled processed tensor and the second upsampled processed tensor to obtain an output of the group of layers of the at least one neural network, wherein the processed tensor comprises the output of the group of layers of the at least one neural network.

Example 23. The apparatus of any of examples 1 to 22, wherein the group of layers of the at least one neural network is used as part of a video encoder or a video decoder.

Example 24. The apparatus of any of examples 1 to 23, wherein the group of layers of the at least one neural network is used as part of an in-loop filter of a video encoder or a video decoder.

Example 25. An apparatus including: at least one processor; and at least one memory storing instructions that, when executed by the at least one processor, cause the apparatus at least to: process a first input tensor using a first subgroup of a group of layers of at least one neural network to obtain a first processed tensor; process a second input tensor using a second subgroup of the group of layers of the at least one neural network to obtain a second processed tensor; and combine the first processed tensor and the second processed tensor, or data derived from the first processed tensor and data derived from the second processed tensor, to obtain an output of the group of layers of the at least one neural network.

Example 26. An apparatus including: at least one processor; and at least one memory storing instructions that, when executed by the at least one processor, cause the apparatus at least to: receive, with at least one first group of layers of a neural network used as part of a data encoder or data decoder, a first input tensor comprising a first spatial resolution; wherein the at least one first group of layers of the neural network comprises two or more second groups of layers of the neural network that process respective two or more second input tensors to obtain respective two or more processed tensors, wherein the two or more second input tensors are derived from the first input tensor; and combine, using a combination operation, the two or more processed tensors, or data derived from the two or more processed tensors, to obtain a combined tensor that is output by the at least one first group of layers.

Example 27. A method including: receiving at least one input tensor; and processing the at least one input tensor using a group of layers of at least one neural network to obtain a processed tensor.

Example 28. A method including: processing a first input tensor using a first subgroup of a group of layers of at least one neural network to obtain a first processed tensor; processing a second input tensor using a second subgroup of the group of layers of the at least one neural network to obtain a second processed tensor; and combining the first processed tensor and the second processed tensor, or data derived from the first processed tensor and data derived from the second processed tensor, to obtain an output of the group of layers of the at least one neural network.

Example 29. A method including: receiving, with at least one first group of layers of a neural network used as part of a data encoder or data decoder, a first input tensor comprising a first spatial resolution; wherein the at least one first group of layers of the neural network comprises two or more second groups of layers of the neural network that process respective two or more second input tensors to obtain respective two or more processed tensors, wherein the two or more second input tensors are derived from the first input tensor; and combining, using a combination operation, the two or more processed tensors, or data derived from the two or more processed tensors, to obtain a combined tensor that is output by the at least one first group of layers.

Example 30. An apparatus including: means for receiving at least one input tensor; and means for processing the at least one input tensor using a group of layers of at least one neural network to obtain a processed tensor.

Example 31. An apparatus including: means for processing a first input tensor using a first subgroup of a group of layers of at least one neural network to obtain a first processed tensor; means for processing a second input tensor using a second subgroup of the group of layers of the at least one neural network to obtain a second processed tensor; and means for combining the first processed tensor and the second processed tensor, or data derived from the first processed tensor and data derived from the second processed tensor, to obtain an output of the group of layers of the at least one neural network.

Example 32. An apparatus including: means for receiving, with at least one first group of layers of a neural network used as part of a data encoder or data decoder, a first input tensor comprising a first spatial resolution; wherein the at least one first group of layers of the neural network comprises two or more second groups of layers of the neural network that process respective two or more second input tensors to obtain respective two or more processed tensors, wherein the two or more second input tensors are derived from the first input tensor; and means for combining, using a combination operation, the two or more processed tensors, or data derived from the two or more processed tensors, to obtain a combined tensor that is output by the at least one first group of layers.

Example 33. A computer readable medium including instructions stored thereon for performing at least the following: receiving at least one input tensor; and processing the at least one input tensor using a group of layers of at least one neural network to obtain a processed tensor.

Example 34. A computer readable medium including instructions stored thereon for performing at least the following: processing a first input tensor using a first subgroup of a group of layers of at least one neural network to obtain a first processed tensor; processing a second input tensor using a second subgroup of the group of layers of the at least one neural network to obtain a second processed tensor; and combining the first processed tensor and the second processed tensor, or data derived from the first processed tensor and data derived from the second processed tensor, to obtain an output of the group of layers of the at least one neural network.

Example 35. A computer readable medium including instructions stored thereon for performing at least the following: receiving, with at least one first group of layers of a neural network used as part of a data encoder or data decoder, a first input tensor comprising a first spatial resolution; wherein the at least one first group of layers of the neural network comprises two or more second groups of layers of the neural network that process respective two or more second input tensors to obtain respective two or more processed tensors, wherein the two or more second input tensors are derived from the first input tensor; and combining, using a combination operation, the two or more processed tensors, or data derived from the two or more processed tensors, to obtain a combined tensor that is output by the at least one first group of layers.

References to a ‘computer’, ‘processor’, etc. should be understood to encompass not only computers having different architectures such as single/multi-processor architectures and sequential/parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, etc.

The term “non-transitory,” as used herein, is a limitation of the medium itself (i.e., tangible, not a signal) as opposed to a limitation on data storage persistency (e.g., RAM vs. ROM).

As used herein, the term ‘circuitry’, ‘circuit’ and variants may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and one or more memories that work together to cause an apparatus to perform various functions, and (c) circuits, such as a microprocessor(s) or a portion of a microprocessor(s), that require software or firmware for operation, even when the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device. Circuitry or circuit may also be used to mean a function or a process used to execute a method.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

The following acronyms and abbreviations that may be found in the specification and/or the drawing figures are defined as follows (the abbreviations may be appended with each other or with other characters using e.g. a hyphen, dash (-), or number (or abbreviations having a character may be the same with a character removed), and may be case insensitive):
2D two-dimensional
3D three-dimensional
4D four-dimensional
APS adaptation parameter set
ASIC application specific integrated circuit
AVC advanced video coding
BaseQP sequence level quantization parameter
BB backbone
BD bit distortion
BD-PSNR bit distortion peak signal-to-noise ratio
BS boundary strength
CABAC context-adaptive binary arithmetic coding
Cb blue-yellow chrominance channel
Conv convolutional or convolution
CPU central processing unit
Cr red-green chrominance channel
CTU coding tree unit
DCT discrete cosine transform
FPGA field programmable gate array
GAN generative adversarial network
H.2xx family of video coding standards in the domain of the ITU-T (e.g. H.263, H.264, H.265, H.266, H.274)
HEVC high efficiency video coding
HMD head-mounted display
IBC intra block copy
IEC International Electrotechnical Commission
I/F interface
Inv inverse
I/O input/output
IPB intra slice (I), predicted or inter slice (P), bidirectional or inter slice (B)
ISO International Organization for Standardization
ITU International Telecommunication Union
ITU-T ITU Telecommunication Standardization Sector
L0 norm number of nonzero elements in the vector
L1 norm sum of the absolute vector values
L2 norm square root of the sum of the squared vector values
MAE mean absolute error
mAP mean average precision
MC motion compensation
ME motion estimation
MPEG moving picture experts group
MSE mean squared error
MS-SSIM multi-scale structural similarity
NAL network abstraction layer
NN neural network
NNC neural network coding
N/W network
Pred prediction
PRELU parameterized rectified linear unit
PS pixel shuffle
QP quantization parameter
RAM random access memory
Rec reconstruction
ROI region of interest
ROM read only memory
Sep separable
SEI supplemental enhancement information
SGD stochastic gradient descent
SliceQP slice-level QP
SON self-organizing/optimizing network
SSIM structural similarity
TV television
UI user interface
USB universal serial bus
VCM video coding for machines
VMAF video multimethod assessment fusion
VSEI versatile supplemental enhancement information
VVC versatile video coding
YUV color model that includes a Y luma component and two chroma components U and V

What is claimed is:

1. An apparatus comprising:
at least one processor; and
at least one memory storing instructions that, when executed by the at least one processor, cause the apparatus at least to:
receive at least one input tensor; and
process the at least one input tensor using a group of layers of at least one neural network to obtain a processed tensor.

2. The apparatus of claim 1, wherein the apparatus is further caused to:
process a first input tensor using a first subgroup of the group of layers of the at least one neural network to obtain a first processed tensor;
process a second input tensor using a second subgroup of the group of layers of the at least one neural network to obtain a second processed tensor; and
combine the first processed tensor and the second processed tensor, or data derived from the first processed tensor and data derived from the second processed tensor, to obtain an output of the group of layers of the at least one neural network;
wherein the processed tensor comprises the output of the group of layers of the at least one neural network.

3. The apparatus of claim 2, wherein at least one of: the first input tensor that is processed using the first subgroup of the group of layers of the at least one neural network is the same as the at least one input tensor, or the second input tensor that is processed using the second subgroup of the group of layers of the at least one neural network is the same as the at least one input tensor.

4. The apparatus of claim 2, wherein at least one of: the first input tensor that is processed using the first subgroup of the group of layers of the at least one neural network is different from the at least one input tensor and is derived from the at least one input tensor, or the second input tensor that is processed using the second subgroup of the group of layers of the at least one neural network is different from the at least one input tensor and is derived from the at least one input tensor.

5. The apparatus of claim 2, wherein the apparatus is further caused to:
downsample the second input tensor that is processed using the second subgroup of the group of layers of the at least one neural network based on a downsampling factor to obtain a downsampled input tensor;
process the downsampled input tensor using the second subgroup of the group of layers of the at least one neural network to obtain an initial second processed tensor; and
upsample, using the second subgroup of the group of layers of the at least one neural network, the initial second processed tensor based on an upsampling factor to obtain the second processed tensor.

6. The apparatus of claim 1, wherein the apparatus is further caused to:
process a luma input, or data from which a luma output is derived, using at least one or more first instances of the group of layers of the at least one neural network to obtain a processed luma;
process a chroma input, or data from which a chroma output is derived, using at least one or more second instances of the group of layers of the at least one neural network to obtain a processed chroma; and
derive the luma output based on the processed luma and derive the chroma output based on the processed chroma.

7. The apparatus of claim 2, wherein the apparatus is further caused to:
process an input tensor using a first convolutional neural network layer to generate an output of the first convolutional neural network layer, wherein the at least one input tensor comprises the output of the first convolutional neural network layer;
process the output of the first convolutional neural network layer using a first separable convolutional neural network layer to obtain an output of the first separable convolutional neural network layer, wherein the first subgroup of the group of layers comprises the first separable convolutional neural network layer and wherein the first processed tensor comprises the output of the first separable convolutional neural network layer;
downsample the output of the first convolutional neural network layer using a downsampling operation to obtain a downsampled output of the first convolutional neural network layer;
process the downsampled output of the first convolutional neural network layer using a second separable convolutional neural network layer to obtain an output of the second separable convolutional neural network layer, wherein the second subgroup of the group of layers comprises the second separable convolutional neural network layer and wherein the second processed tensor comprises the output of the second separable convolutional neural network layer;
upsample the output of the second separable convolutional neural network layer using an upsampling operation to obtain an upsampled output of the second separable convolutional neural network layer, so that the upsampled output of the second separable convolutional neural network layer has the same resolution as the output of the first separable convolutional neural network layer;
sum, using a first summing operation, the output of the first separable convolutional neural network layer and the upsampled output of the second separable convolutional neural network layer to obtain a summed output;
process the summed output by using a second convolutional neural network layer to obtain an output of the second convolutional neural network layer; and
sum, using a second summing operation, the output of the second convolutional neural network layer with a luma input or a chroma input to obtain an output tensor.

8. The apparatus of claim 7, wherein the input tensor comprises at least one of the luma input, the chroma input, data from which luma data is derived, or data from which chroma data is derived.

9. The apparatus of claim 7, wherein the group of layers of the at least one neural network comprises: the first separable convolutional neural network layer, the downsampling operation, the second separable convolutional neural network layer, the upsampling operation, and the first summing operation.

10. The apparatus of claim 7, wherein the at least one input tensor comprises the output of the first convolutional neural network layer.

11. The apparatus of claim 7, wherein the processed tensor comprises the summed output.

12. The apparatus of claim 1, wherein the apparatus is further caused to:
process the at least one input tensor using a first subgroup of the group of layers of the at least one neural network to obtain a first processed tensor;
downsample the at least one input tensor using a downsampling operation based on a downsampling factor to obtain a downsampled input tensor;
process the downsampled input tensor using a second subgroup of the group of layers to obtain a second processed tensor;
upsample the second processed tensor using an upsampling operation based on an upsampling factor to obtain an upsampled processed tensor, such that the upsampled processed tensor has the same resolution as the at least one input tensor processed using the first subgroup or the first processed tensor; and
combine the first processed tensor and the upsampled processed tensor to obtain an output of the group of layers of the at least one neural network, wherein the processed tensor comprises the output of the group of layers of the at least one neural network.

13. The apparatus of claim 1, wherein the group of layers of the at least one neural network is used as part of a video encoder or a video decoder.

14. The apparatus of claim 1, wherein the group of layers of the at least one neural network is used as part of an in-loop filter of a video encoder or a video decoder.

15. A method comprising:
receiving at least one input tensor; and
processing the at least one input tensor using a group of layers of at least one neural network to obtain a processed tensor.

16. The method of claim 15 further comprising:
processing a first input tensor using a first subgroup of the group of layers of the at least one neural network to obtain a first processed tensor;
processing a second input tensor using a second subgroup of the group of layers of the at least one neural network to obtain a second processed tensor; and
combining the first processed tensor and the second processed tensor, or data derived from the first processed tensor and data derived from the second processed tensor, to obtain an output of the group of layers of the at least one neural network;
wherein the processed tensor comprises the output of the group of layers of the at least one neural network.

17. The method of claim 16, wherein at least one of: the first input tensor that is processed using the first subgroup of the group of layers of the at least one neural network is the same as the at least one input tensor, or the second input tensor that is processed using the second subgroup of the group of layers of the at least one neural network is the same as the at least one input tensor.

18. The method of claim 16, wherein at least one of: the first input tensor that is processed using the first subgroup of the group of layers of the at least one neural network is different from the at least one input tensor and is derived from the at least one input tensor, or the second input tensor that is processed using the second subgroup of the group of layers of the at least one neural network is different from the at least one input tensor and is derived from the at least one input tensor.

19. The method of claim 16 further comprising:
downsampling the second input tensor that is processed using the second subgroup of the group of layers of the at least one neural network based on a downsampling factor to obtain a downsampled input tensor;
processing the downsampled input tensor using the second subgroup of the group of layers of the at least one neural network to obtain an initial second processed tensor; and
upsampling, using the second subgroup of the group of layers of the at least one neural network, the initial second processed tensor based on an upsampling factor to obtain the second processed tensor.

20. The method of claim 15 further comprising:
processing a luma input, or data from which a luma output is derived, using at least one or more first instances of the group of layers of the at least one neural network to obtain a processed luma;
processing a chroma input, or data from which a chroma output is derived, using at least one or more second instances of the group of layers of the at least one neural network to obtain a processed chroma; and
deriving the luma output based on the processed luma and derive the chroma output based on the processed chroma.
